(19) United States
(12) Patent Application Publication
(10) Pub. No.: US 2026/0112939 A1
(43) Pub. Date: Apr. 23, 2026

(54) PLUG-IN POTHEAD AND METHOD FOR ELECTRICAL SUBMERSIBLE MOTORS

(71) Applicant: Halliburton Energy Services, Inc., Houston, TX (US)

(72) Inventor: Andras Bencze, Frimley (GB)

(21) Appl. No.: 18/919,176

(22) Filed: Oct. 17, 2024

(51) Int. Cl. H02K 5/132; E21B 43/12; H01R 13/52; H01R 13/621; H01R 43/26; H02K 5/22

(52) U.S. Cl. CPC H02K 5/132; E21B 43/128; H01R 13/5219; H01R 13/6215; H01R 43/26; H02K 5/225

(57) ABSTRACT

Some implementations include a system comprising a connector configured to electrically couple a motor lead extension (MLE) to an electric motor of an electrical submersible pump (ESP) to be positioned in a wellbore, wherein the connector includes a first set of cavities each including a first conductor. The system further includes a motor head of the electric motor including a second set of cavities configured to receive the first conductors, where each cavity of the second set of cavities includes a second conductor, an electrical coupling device configured to electrically couple each of the first conductors to a respective second conductor, a set of threads, and a locking device configured to form a threaded connection with the set of threads, wherein the locking device is configured to prevent an axial movement of the electrical coupling device and the second conductor within each cavity of the second set of cavities.

### TECHNICAL FIELD

The disclosure generally relates to subsurface-capable tools for use in wellbores formed in subsurface formations, and more particularly, to electric motors of electrical submersible pumps used to extract hydrocarbons or other fluids from subsurface formations.

### BACKGROUND

Electrical submersible pumps (ESPs) may be deployed in a wellbore to pump fluid from one or more underground reservoirs to the surface. ESP assemblies may typically comprise one or more joints of production tubing, a pump discharge head, one or more centrifugal pumps, a pump intake, a gas-separator, one or more seal sections, one or more electric motors, a downhole gauge, a motor lead extension (MLE) and a surface cable. The electric motor(s) may be energized from the surface via the surface cable to produce the required torque to drive the pumps and produce fluid to surface.

The MLE may comprise a flat cable terminated into a connector with male electrical pins. This connector having male electrical pins may be referred to as a pothead. The pothead may be configured to connect to a female receptacle located in the motor head. Most standard ESP motor connections (which may be referred to as tape-in pot-head connectors) may require preparation during the field installation of the ESP. The preparation of the connection may typically comprise pulling the motor lead wire out from the motor head, securing the electrical receptacles to the motor lead wire, connecting individual electrical sockets of the motor head to the individual pins on the pothead connector, insulating each individual pin-socket joint, and then inserting the entire assembly back into the motor head (usually the latter is a blind assembly). During this preparation and assembly process, the connector components may be exposed to the environment (dust, rain, sun, ice, etc.) for extended periods of time, which may cause damage to the connector components. The contamination and damage from environmental exposure during assembly/preparation may lead to reduced performance and/or failures of the electrical connection during the assembly process or during operation of the ESP in the wellbore. Additionally, the process of creating a tape-in connection may require time and skilled personnel. Therefore, human error and variability may be present during the assembly process.

### BRIEF DESCRIPTION OF THE DRAWINGS

Implementations of the disclosure may be better understood by referencing the accompanying drawings.

FIG. 1 is an isometric view depicting an example electric motor of an electrical submersible pump (ESP) that includes an example motor lead extension (MLE), according to some implementations.

FIG. 2 is a close-up isometric view depicting an example MLE on a motor head in a disconnected state, according to some implementations.

FIG. 3 is a close-up isometric view depicting the example MLE on the motor head in a connected state, according to some implementations.

FIG. 4 is a top view depicting an example pothead and motor connection while the pothead is partially engaged with the securing studs on the motor head, according to some implementations.

FIG. 5 is an axial cross section depicting the example pothead and motor connection of FIG. 4 while the pothead is partially engaged with the securing studs on the motor head, according to some implementations.

FIG. 6 is an axial section view depicting one of the phases of an example plug-in pothead and motor head connector (receptacle), showing the example plug-in pothead in an un-mated state, according to some implementations.

FIG. 7 is a first axial section view depicting one of the phases of the example plug-in pothead and motor head connector (receptacle), showing the example plug-in pothead in a mated state, according to some implementations.

FIG. 8 is a first illustration depicting example creepage paths and minimum insulation thickness of the mated plug-in pothead, according to some implementations.

FIG. 9 is an example plot depicting creepage curves in air over smooth organic insulation, according to Reuben.

FIG. 10 is an isometric view depicting the example plug-in pothead separated from the motor, according to some implementations.

FIG. 11 is an isometric view depicting an example motor head and the connection ports in the motor head, according to some implementations.

FIG. 12 is a first exploded isometric view depicting the example plug-in pothead and pothead components, according to some implementations.

FIG. 13 is a first axial section view through one of the phases of the example plug-in pothead, showing the example plug-in pothead assembly with one conductor size, according to some implementations.

FIG. 14 is a first axial section view depicting one of the phases of the example plug-in pothead, showing the example plug-in pothead assembly with an alternate conductor size, according to some implementations.

FIG. 15 is an exploded isometric view depicting the example plug-in pothead mating connector (receptacle) of the motor head, according to some implementations.

FIG. 16 is a first axial section view depicting one of the phases of the example plug-in pothead mating connector (receptacle) in the motor head, according to some implementations.

FIG. 17 a detailed view of the axial section of FIG. 16 depicting one of the phases of the example plug-in pothead mating connector (receptacle) in the motor head, according to some implementations.

FIG. 18 is a radial section view of FIG. 16 depicting the example plug-in pothead mating connector (receptacle) in the motor head, according to some implementations.

FIG. 19 is a second exploded isometric view depicting the example plug-in pothead and pothead components, according to some implementations.

FIG. 20 is a second axial section view depicting one of the phases of the example plug-in pothead, showing the assembled plug-in pothead with one conductor size, according to some implementations.

FIG. 21 is a second axial section view depicting one of the phases of the plug-in pothead, showing the assembled plug-in pothead with an alternate conductor size, according to some implementations.

FIG. 22 is a second axial section view depicting one of the phases of the example plug-in pothead mating connector (receptacle) in the motor head, according to some implementations.

FIG. 23 is a second axial section view depicting one of the phases of the example plug-in pothead and motor head connector (receptacle), showing the example plug-in pothead in a mated state, according to some implementations.

FIG. 24 is a second illustration depicting example creepage paths and a minimum insulation thickness of the mated plug-in pothead, according to some implementations.

FIG. 25 is an illustration depicting an example well system having an ESP, according to some implementations.

FIG. 26 is a flowchart depicting an example method of operations, according to some implementations.

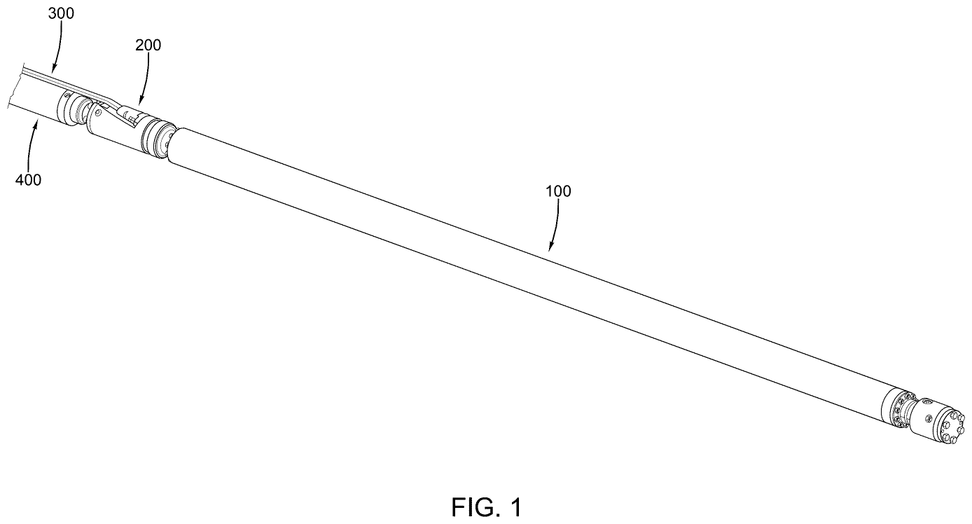

FIGS. 1-26 and the operations described herein are examples meant to aid in understanding example implementations and should not be used to limit the potential implementations or limit the scope of the claims. None of the implementations described herein may be performed exclusively in the human mind nor exclusively using pencil and paper. Some implementations may perform additional operations, fewer operations, operations in parallel or in a different order, and some operations differently.

The description that follows includes example systems, methods, techniques, and program flows that embody implementations of the disclosure. However, it is understood that this disclosure may be practiced without these specific details. In other instances, well-known instruction instances, protocols, structures, and techniques have not been shown in detail in order not to obfuscate the description.

### DESCRIPTION

Example implementations may include a pothead design and method of field installation which may minimize the above-mentioned risks and issues from environmental exposure, human error, etc. This type of pothead design may be referred to as a plug-in pothead or a plug-in connector. Plug-in potheads may include certain advantages over conventional tape-in potheads because they may be configured to form a plug-in type of connection with the motor head of the electric motor of the ESP. The example plug-in pothead described herein may include advantages over more traditional pothead designs, such as overlapping internal insulators, the ability to accommodate at least two different conductor sizes within the same pothead housing, the use of a locking mechanism for electrical terminal retention to enable the plug-in type of connection, using an insulation system without the use of threaded connections, the ability to use a two-piece insulator or a single-piece insulator in the pothead, the ability to machine and/or mold the single-piece insulator, interchangeability between the machined or molded insulators in the pothead, the ability to use both hermetically sealed or unsealed configurations for the receptacle in the motor head, etc. The use of a plug-in connection may eliminate the need for preparation at the well site during field installation, thus reducing assembly time, the potential of contamination/damage, etc. For example, the risk of contamination and damage to the connection formed between the plug-in pothead and the motor head during field deployment may be minimized by the plug-in connection technique which may improve the electrical performance and reliability of the ESP's electric motor.

At the well site, a field technician or similar personnel may remove a protective cap from the motor head and a similar protective cap from the pothead. The plug-in pothead may be positioned and aligned with a connection port on the motor head. The field technician may slide the pothead to engage the connection between the plug-in pothead and motor head. Theoretically, this type of connection may be completed within a short period of time. Due to the weather conditions, some preliminary preparations of the work area may be required, although traditional tape-in pothead connections may also require some degree of work area preparation. However, when compared to traditional tape-in connectors, the required training for the field technician (or similar personnel) to perform the plug-in type of connector installation may be minimal. Basic mechanical and electrical knowledge and standard field installation skills may be amply sufficient.

Example implementations may include a plug-in connector configured for use with traditional motor head designs and existing pothead components. In some implementations, the plug-in pothead design may be derived from and use many of the same components from a standard tape-in pothead design but may instead be configured for the plug-in type of connection. Therefore, existing inventory may be utilized with minimum geometrical changes to the motor head (e.g., pothead bore dimensions may be slightly modified, with the option of upgrading existing motor heads). Motors with a modified pothead bore on the motor head may be used with either plug-in or tape-in potheads. The option to revert to a standard tape-in pothead may be available by simply removing the motor head connector components, even at the well site. Accordingly, several internal components of the plug-in connector may be interchangeable with a comparable tape-in pothead.

Example implementations may include a plug-in connector having a modified electrical insulation system compared to traditional potheads. For example, the connector pins and sockets of the plug-in pothead described herein may be preassembled into custom-made electrically insulating components in the motor head and pothead respectively. The material of the insulators may include organic materials, such as Polyether ether ketone (PEEK), or the material of the insulators may include non-organic materials, such as ceramic. Other materials may also be possible. Because the connection components may be tightly installed inside the motor head and the connector housing, there may be a reduced risk of fatigue failure of the electrical connection due to vibration over the run-life of the ESP. If a sealed configuration of the motor head connector is utilized, the motor may be serviced prior to shipping to the field, thus eliminating the need for field servicing. Some implementations of the example plug-in pothead described herein may also comprise a more compact design compared to traditional tape-in potheads.

The modified example insulation system may be configured to decrease discharge and/or grounding events. For example, the bare conductors in both the pothead and the motor head may be enclosed in insulators comprised of PEEK, ceramic, or other high dielectric strength materials. A high dielectric strength material may be considered to possess a dielectric strength of greater than or equal to approximately 20 kilovolts per millimeter (kV/mm). Other values and materials may also be possible. The challenge with such systems in limited spaces is to design for adequate creepage distances provided by the paths between the conductors (live terminals) and the metal body (ground) or between two conductors (live terminals). The example plug-in connector as described herein may be optimized for maximum creepage lengths for the given space, thus increasing a flashover voltage limit for the mated connection as presented. Improvements may be possible with some design changes within the given space constraints. In some implementations, a two-piece insulator or single piece insulator may be used for the pothead. The single piece insulator, however, may provide cost reductions for mass production with minimum to no machining.

The example plug-in connector may also be designed to accommodate two different conductor sizes inside the same pothead housing. Similarly, the motor head connector may also be configured to accommodate two different conductor sizes. By designing the optimal location of the plug-in pothead electrical pins within the pothead housing, two different conductor sizes (e.g., #7 American Wire Gauge (AWG) and #6 AWG) may be accommodated in the same pothead housing and motor head connection. This provides the option for either a three or five kilovolt (kV) cable to be used for the same motor size. Other conductor sizes and cable ratings may also be possible.

Example implementations of the motor head connector (receptacle) may also include both sealed and unsealed configurations. In certain circumstances, it may be required that the motor be hermetically sealed when it arrives at a field location. The design of the motor head connector (receptacle) may allow for either the unsealed or sealed configuration, the sealing being achieved by adding O-rings to the insulator of the connector and the individual electrical sockets in the motor head.

### Example Illustrations

FIG. 1 is an isometric view depicting an example electric motor of an electrical submersible pump (ESP) that includes an example motor lead extension (MLE), according to some implementations. FIG. 1 includes a typical electric motor 100 utilized in electrical submersible pump (ESP) applications. The electric motor 100 may be powered from the surface through a power cable (main cable, round profile), which may cross over to a motor lead extension (MLE) 300. The MLE 300 may include a flat cable, although other cable types (e.g., a round cable) may also be used. The MLE 300 may be positioned above the pumps to minimize radial height of the cable over the length of the electrical submersible pump (ESP) system. The MLE 300 may terminate in a pothead/connector 200. A seal section 400 of the ESP assembly may be positioned directly above the motor 100.

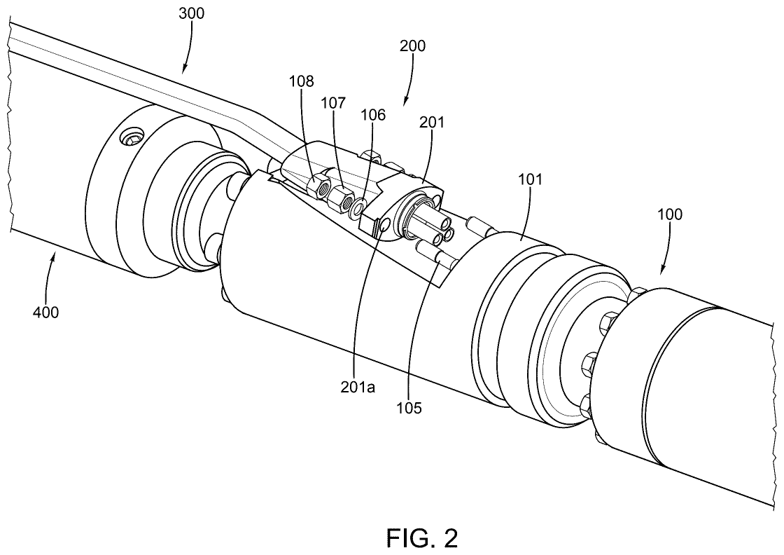

FIG. 2 is a close-up isometric view depicting an example MLE on a motor head in a disconnected state, according to some implementations. FIG. 2 includes the motor 100, a motor head body 101 (motor head 101), securing studs 105, washers 106, fasteners 107, fasteners 108, the plug-in pothead 200, pothead housing 201 through-holes 201a, the MLE 300, and the seal section 400.

The plug-in pothead 200 as shown in FIG. 2, may be in a disconnected state from the motor 100. The motor 100 may include the motor head body 101. The plug-in pothead 200 (also referred to as a plug-in connector 200) may be aligned with one or more receptacles of the motor head body 101. The plug-in pothead 200 may include the pothead housing 201. A through-hole 201a positioned on each side of the pothead housing 201 (which may also be referred to as a connector housing 201) may be configured to align with a respective securing stud 105 of the motor head body 101. The pothead housing 201 may be configured to receive and house at least a portion of a cable, such as the MLE 300, having one or more conductors. When the plug-in connection of the plug-in pothead 200 is engaged, the plug-in pothead 200 may be secured to the motor head body 101 by washers 106 and fasteners 107, 108. In some implementations, each of the fasteners 107 and fasteners 108 may include a lug configured to form a threaded connection with its respective securing stud 105. As shown, the plug-in pothead 200 may be disconnected from the motor 100 before the field connection to the motor 100 is performed.

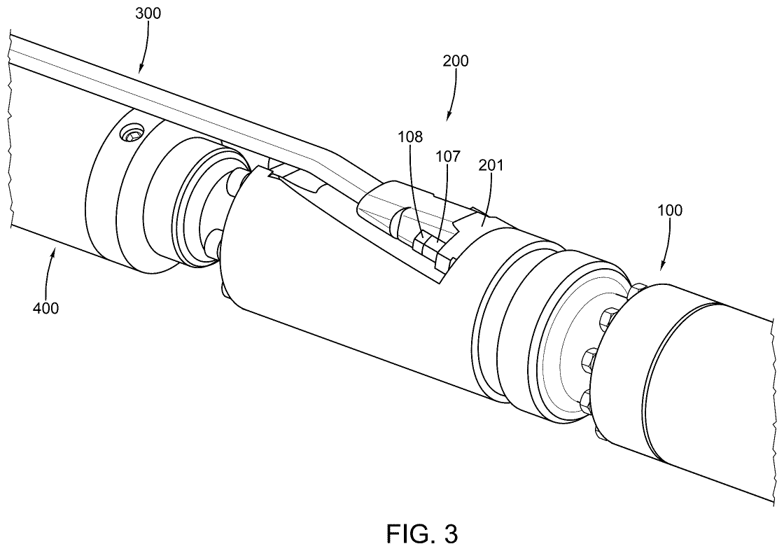

FIG. 3 is a close-up isometric view depicting the example MLE 300 on the motor head in a connected state, according to some implementations. FIG. 3 includes the motor 100, MLE 300, and seal section 400, the fasteners 107, fasteners 108, plug-in connector 200, and pothead housing 201. As shown, the plug-in pothead 200 of FIG. 2 may be connected to the motor 100 via a plug-in connection, and the pothead housing 201 may be secured in place via the fasteners 107 and 108.

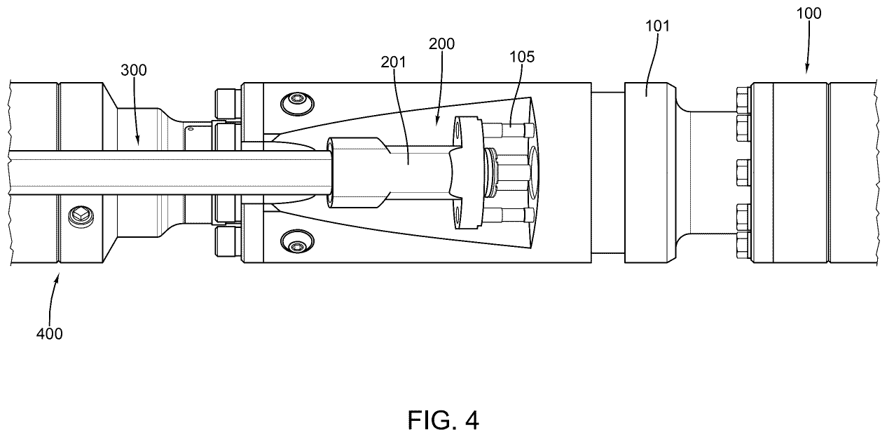

FIG. 4 is a top view depicting an example pothead and motor connection while the pothead is partially engaged with the securing studs on the motor head, according to some implementations. FIG. 4 includes the motor 100, MLE 300, and seal section 400, motor head body 101, securing stud 105, plug-in pothead 200, pothead housing 201. In FIG. 4, the pothead 200 is shown in an intermediate position, where the pothead housing 201 may be partially engaged with the securing studs 105 protruding from the motor head 101.

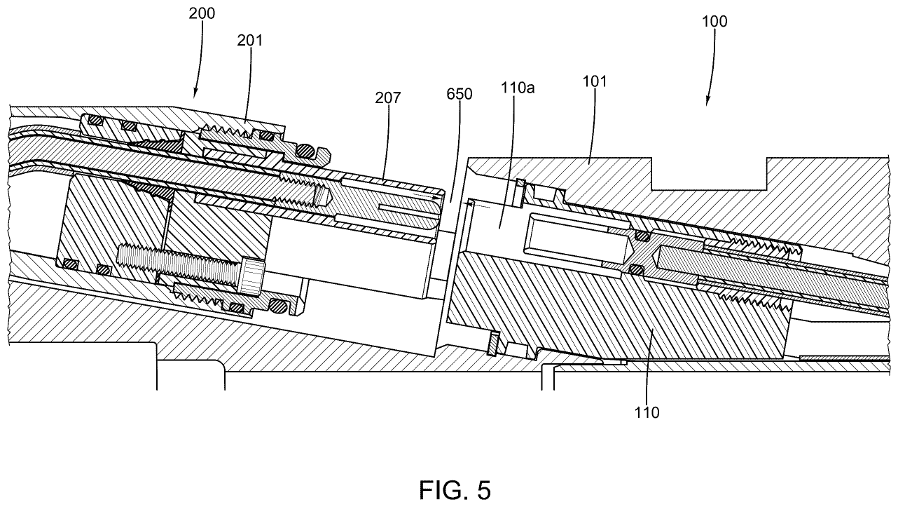

FIG. 5 is an axial cross section depicting the example pothead and motor connection of FIG. 4 while the pothead is partially engaged with the securing studs on the motor head, according to some implementations. FIG. 5 includes the motor 100, motor head body 101, plug-in connector 200, pothead housing 201, a motor head insulator body 110, a receptacle bore 110a (also referred to as an electrical pin bore), the pothead housing 201, a pin insulating sleeve 207, and a gap 650. Similar to FIG. 4, the plug-in pothead 200 is also depicted in an intermediate position partially engaged with the securing stud 105. In this position, there may still remain a considerable gap 650 between the pothead pin insulating sleeve 207 and the motor head insulator body 110. The plug-in pothead 200 may be guided by the securing studs 105, thus ensuring that all pin insulating sleeves 207 of the pothead 200 may engage smoothly with the receptacle bore 110a of the motor head insulator body 110. The receptacle bore 110a of the motor head insulator body 110 and the insulating sleeves 207 may not act as a guide for the pothead 200 during the field installation.

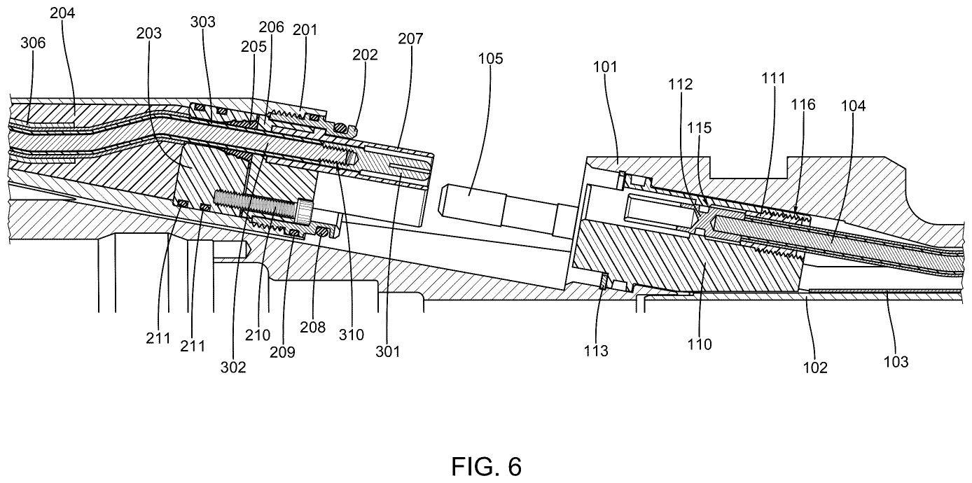

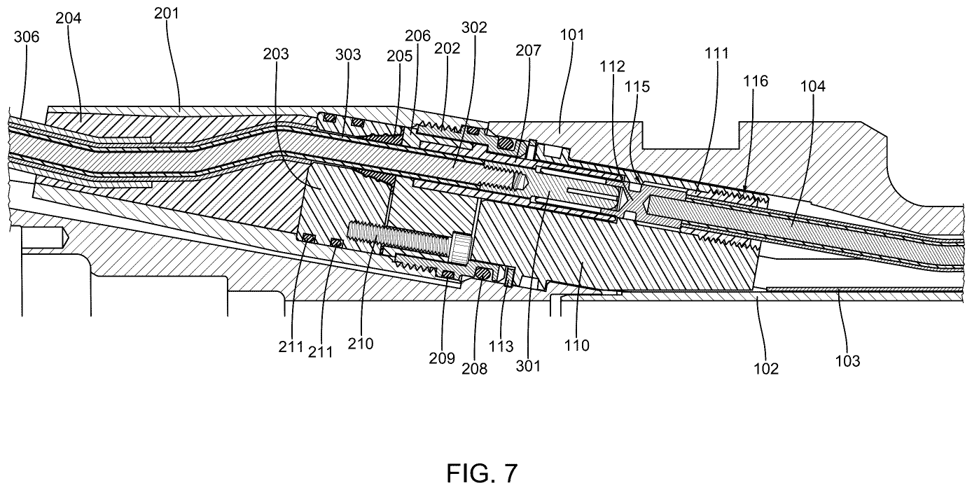

FIGS. 6 and 7 depict un-mated and mated configurations of the example plug-in connector 200 into the motor head body 101, respectively. FIG. 6 is an axial section view depicting one of the phases of an example plug-in pothead and motor head connector (receptacle), showing the example plug-in pothead in an un-mated state, according to some implementations. FIG. 6 includes the motor head body 101, a motor lead guard 102, an insulating sleeve 103, a motor flexible lead extension 104 (also referred to as a motor lead 104), securing studs 105, the motor head insulator body 110, a locking nut 111 (also referred to as a lock nut), a motor head female electrical connector 112, a retaining ring 113, a contact region 115, a threaded connection 116, the pothead housing 201, a compression ring 202, an upper compression block 203, the epoxy resin 204, an elastomeric seal 205, a lower compression block 206, a pin insulating sleeve 207, an O-ring 208, an O-Ring 209, a screw 210, O-rings 211, plug-in pothead male electrical connector 301 (also referred to as the electrical pin 301), a conductor 302, an insulation layer 303, an MLE armor 306, and a threaded connection 310. Each conductor 302 may be included as part of a respective phase of the electrical connection. For example, a three-phase connector may include three individual conductors. Each conductor 302 may be coupled with the electrical pin 301. In some implementations, the electrical pin 301 may be comprised of a solid copper pin. However, other conductive materials may also be used. The elastomeric seal 205 may be comprised of an elastomeric material and may be electrically insulative. The motor head female electrical connector 112 may be an electrical terminal or similar device configured to electrically couple each motor lead 104 to each respective conductor 302 when forming the plug-in connection. The insulating sleeve103 may be a secondary insulating component configured to provide an insulating layer between the motor flexible lead extensions 104 and the lead guard 102 in the motor head body 101.

FIG. 7 is a first axial section view depicting one of the phases of the example plug-in pothead and motor head connector (receptacle), showing the example plug-in pothead in a mated state, according to some implementations. FIG. 7 includes the motor head body 101, the motor lead guard 102, the insulating sleeve 103, the motor flexible lead extension 104, the motor head insulator body 110, the locking nut 111, motor head female electrical connector 112, the retaining ring 113, the contact region 115, the threaded connection 116, the pothead housing 201, a compression ring 202, an upper compression block 203, the epoxy resin 204, an elastomeric seal 205, a lower compression block 206, an insulator sleeve 207, an O-ring 208, an O-Ring 209, a screw 210, O-rings 211, the plug-in pothead male electrical connector 301, one or more conductors 302 (one for each phase of the electrical connection), the insulation layer 303, and the MLE armor 306.

With reference to FIGS. 6-7, the pothead housing 201 may enclose the electrical connection system terminated onto the ESP cable's (MLE 300) individual phases/conductors 302. The three conductors 302 of the MLE 300 may be inserted from a rear end of the pothead housing 201 through three cavities in each of the upper compression block 203, of the elastomeric seal 205, and of the lower compression block 206. These cavities may be positioned in a precise location on a predefined pitch circle diameter such that all three phases are spaced evenly. In some implementations, and in contrast to traditional pothead designs, two different conductor sizes may be used in the same pothead housing 201 for different applications (i.e., lower voltage applications may utilize three kilovolt—#7 AWG conductors, whereas higher voltage applications may utilize five kilovolt—#6 AWG conductors. The same pothead housing 201 may accommodate either conductor configuration, whereas traditional configurations may utilize one pothead housing for the #7 AWG conductors and one pothead housing for the #6 AWG conductors.

By tightening the screws 210 into the upper compression block 203, the screws 210 may apply force onto the lower compression block 206, pressing the elastomeric seal 205 against the upper compression block 203. This may occur for each conductor and/or phase 302 of the plug-in connector 200. This pressure in turn, may squeeze the individual sealing elements of the elastomeric seal 205 against the insulation layer 303 of the individual conductors 302. The epoxy resin 204 may also be used to encapsulate the rear section of the plug-in pothead 200. As shown, overlapping insulation, such as the elastomeric seal 205, lower compression block 206, and pin insulating sleeve 207 may be used for each conductor 302.

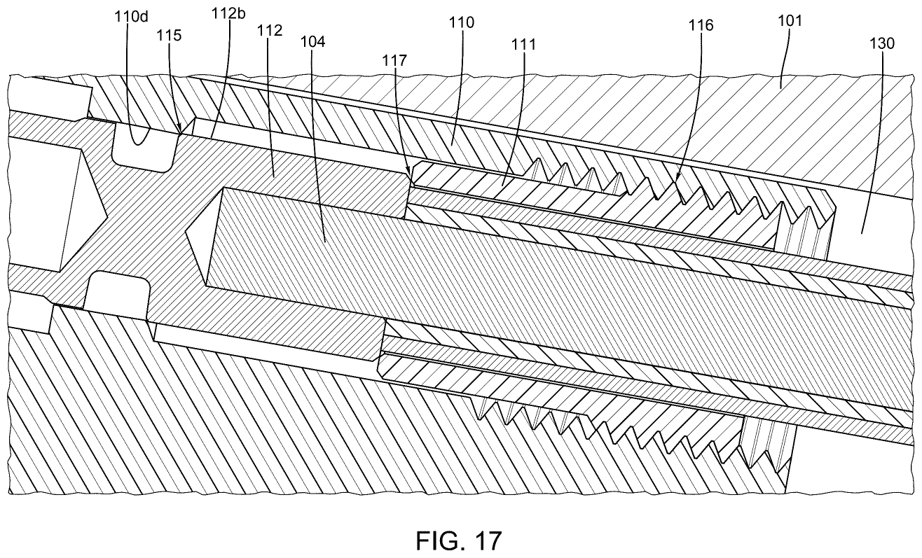

The technique for achieving the plug-in connection between the pothead 200 and motor head body 101 may be different than that of traditional pothead and motor head receptacle designs while still using many of the same components present in traditional tape-in pothead designs. For example, the locking nut 111 may be used to lock each of the motor leads 104 within the motor head insulator body 110. The locking nut 111 may be threaded into the motor head insulator body 110, shouldering each pin of the motor lead 104 in the motor head female electrical connector 112 between the contact region 115 and contact region 117 (see FIG. 17). The motor head female electrical connector 112 may be lodged between two surfaces (the locking nut 111 and a smaller inner diameter portion of the motor head insulator body 110) and may not be pulled back into the motor or pulled out of the motor. The motor lead 104 may also be locked in place within the motor head female electrical connector 112. Accordingly, each motor head female electrical connector 112 may remain in place during connecting and disconnecting the pothead 200, thus enabling a plug-in type of connection. Traditional motor head receptacle designs, such as those used with tape-in potheads, may utilize a split female electrical connector 112, whereas the female electrical connector 112 of the plug in pothead may be comprised of a full pin. Using a full pin versus a split pin may reduce the effect on the electrical properties of the female electrical connector 112 (i.e., higher contact resistance due to a threaded connection) and increased durability of the plug-in connection.

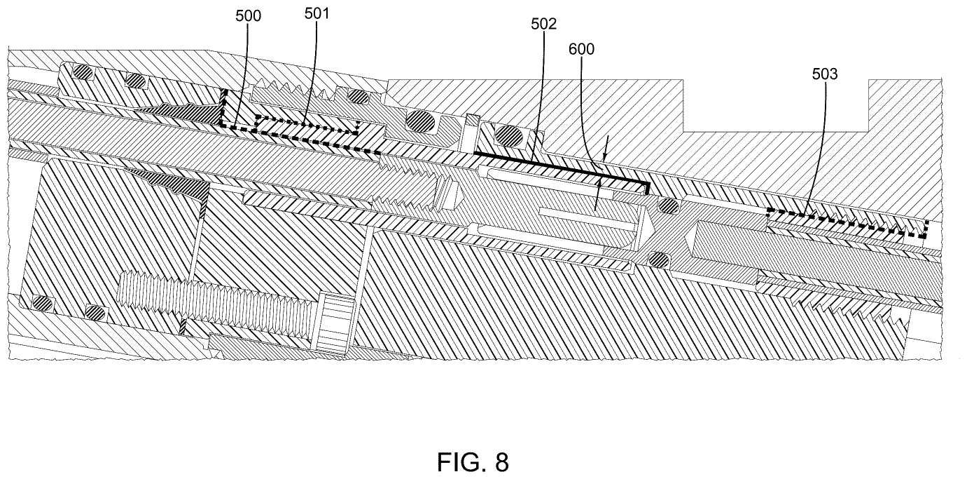

FIG. 8 is a first illustration depicting example creepage paths and minimum insulation thickness of the mated plug-in pothead, according to some implementations. FIG. 8 includes a creepage path 500, a creepage path 501, a creepage path 502, creepage path 503, and a minimum wall thickness 600. For an insulation system similar to those described, it may be important to maximize the creepage distances between the live terminals and a potential ground. Maximizing the creepage distances may increase the flashover voltage level between live terminals and ground or between live terminals. As shown in FIG. 8, the ground may be the pothead housing 201 or the motor head body 101. The creepage paths may be comprised of air gaps between the insulation. A creepage distance along a creepage path may refer to the distance in air over an organic/inorganic insulating material at which an electric flashover or electric arcing may occur at a given potential differential. An established method of increasing the creepage distance is to provide as much overlap as possible between insulating components. Insulating components such as the elastomeric seal 205, lower compression block 206, and pin insulating sleeve 207 may be overlapped to provide insulation for each conductor 302 and electrical pin 301. These overlapping insulators may also extend the creepage distances of creepage paths within the pothead 200 and motor head receptacle. Therefore, the pothead 200 may be able to utilize higher voltages through the MLE 300 than traditional potheads with lower risks of shorting. Traditional pothead designs may use insulating tape wrapped around the individual mated connectors which may have variable thickness thus leading to reduced creepage paths and/or reduced insulation thickness in the electrical connection, making partial discharges and/or grounding more likely to occur.

As shown per FIG. 8, multiple creepage paths may be present in the mated plug-in pothead. The creepage paths 500, 501, 502, and 503 may describe the air gaps between insulation components present in the plug-in connection. The creepage path 500 may be positioned between the male electrical connector (electrical pin) 301 of the plug-in pothead and the pothead housing 201. In one example scenario, the creepage distance of the creepage path 500 may be approximately ˜20.4 mm (˜0.803″). The creepage path 501 may be positioned between the plug-in pothead male electrical connector 301 and the compression ring 202. Specifically, the creepage path 501 may comprise the air gap between the lower compression block 206 and the insulator sleeve 207. The creepage path 501 may have a creepage distance of approximately ˜25.4 mm (˜1″). The creepage path 502 may be positioned between the motor head female electrical connector 112 and the retaining ring 113. The creepage path 502 may include a creepage distance of approximately ˜19.2 mm (˜0.756″). The creepage path 503 may be positioned between the motor head female electrical connector 112 and the motor head body 101 and have a creepage distance of approximately ˜19.1 mm (˜0.755″). Other creepage distances may be possible. The minimum wall thickness 600 of the PEEK insulator in the assembly (the motor head insulator body 110) may measure ˜1 mm (˜0.040″). This minimum wall thickness may refer to a minimum thickness of the insulating material to ensure that no short occurs through the material itself. Other measurements for the creepage distances and minimum wall thickness may also be possible.

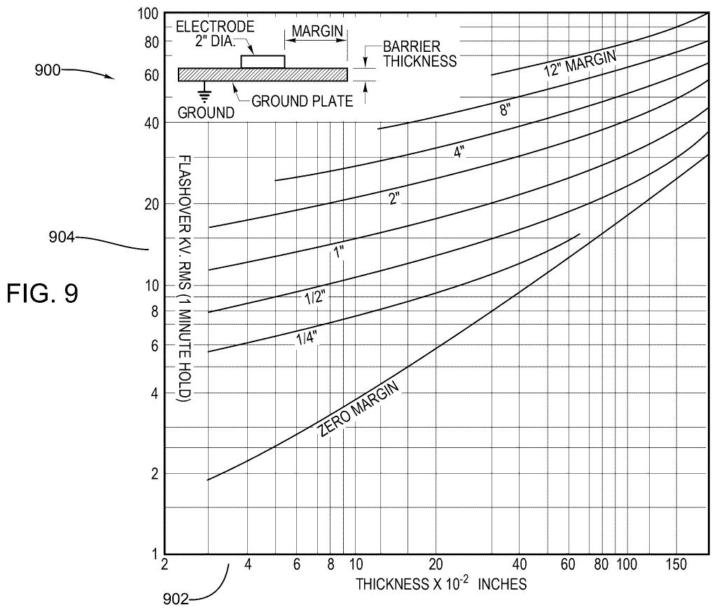

FIG. 9 is an example plot 900 depicting creepage curves in air over smooth organic insulation, according to Reuben. The plot 900 includes an X-axis 902 of insulating material minimum wall thickness in inches and a Y-axis 904 depicting a flashover voltage in kilovolts (kV). Based on the minimum creepage distance and minimum wall thickness of the insulating components, the minimum flashover voltage may be estimated from the curve presented in FIG. 9 (from Reuben Lee's “Electronic Transformers and Circuits” published in 1955 2nd Edition Lib. of Congress No. 55-10001). Considering the insulating material minimum wall thickness of 1 mm (˜0.04″) from FIG. 8 and the minimum creepage distance of ˜19.1 mm (a margin of ˜0.755″ or ˜¾″), the flashover voltage according to the graph in FIG. 9 may be estimated to 11 kV of alternating current (AC). In some implementations, this voltage may be higher, as the assembled plug-in pothead may be submerged in dielectric oil. In some implementations, the dielectric strength of the insulation material included in the plug-in pothead 200 may be 25 kV/mm; therefore for a 1 mm (˜0.04″) insulator wall thickness, the breakdown voltage may equal 25 kV AC. The above-described example creepage distances may be readily increased by altering the dimensions of the insulation components comprised of the lower compression block 206, insulating sleeve 207, and motor head insulator body 110. The dimensions of the insulation components may depend on the space availability in the motor head 101 and the pothead 200. The flashover voltage may also be increased accordingly.

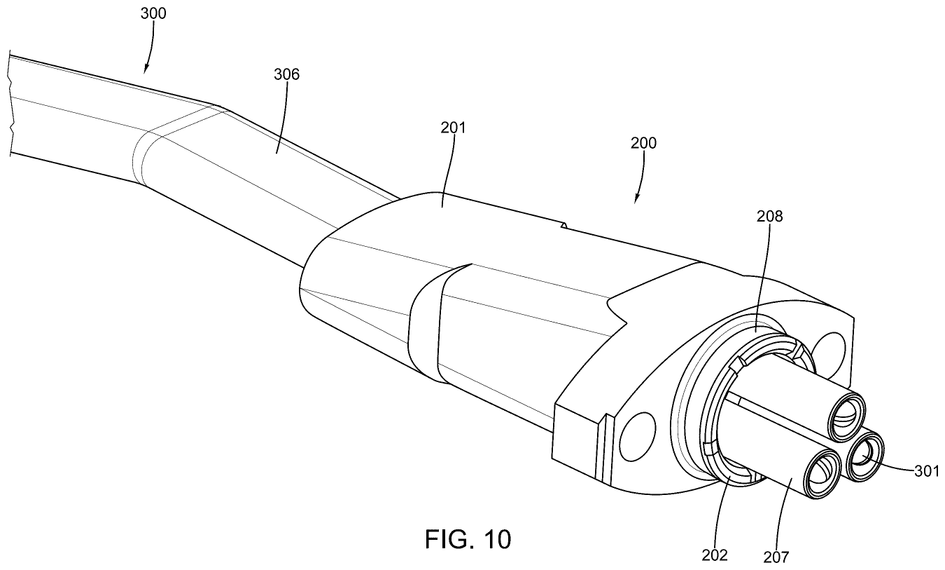

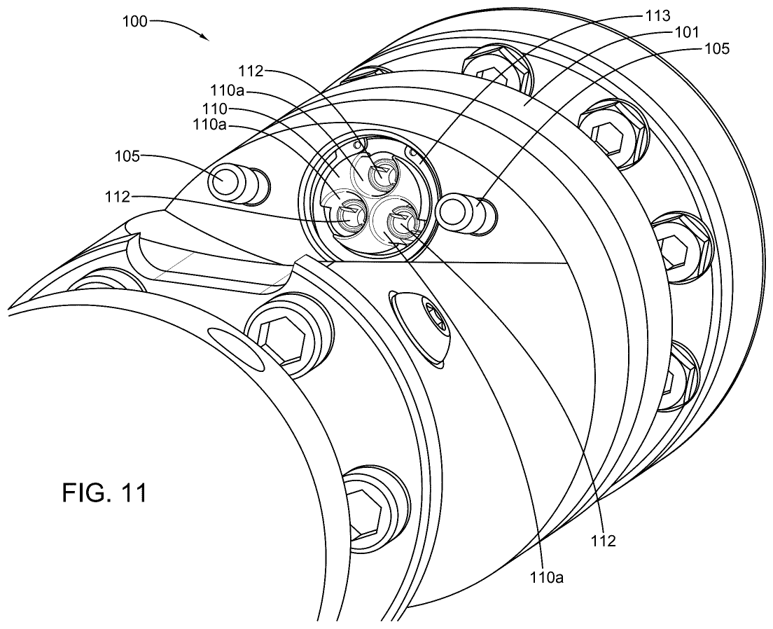

FIG. 10 and FIG. 11 depict the assembled pothead 200 and the assembled motor head connector (receptacle) in the motor head 101 in an un-mated state. In some implementations, some of the details of the plug-in pothead 200 and motor head connector may be visible—namely, the three phase arrangement on both halves of the connection, as well as the details of an electrical connector cavity (receptacle bore 110a) in the motor head insulator body 110.

FIG. 10 is an isometric view depicting the example plug-in pothead 200 separated from the motor 100, according to some implementations. FIG. 10 includes the plug-in pothead 200, pothead housing 201, a compression ring 202, insulating sleeve 207 (three are shown), O-ring 208, MLE 300, the plug-in pothead male electrical connector 301 (three are shown), and the MLE armor 306.

FIG. 11 is an isometric view depicting an example motor head and the connection ports in the motor head, according to some implementations. FIG. 11 includes the motor 100, motor head body 101, securing studs 105 (two are shown), the motor head insulator body 110, three receptacle bores 110a comprised of three electrical connector cavities, the motor head female electrical connectors 112 (three are shown), and the retaining ring 113.

As shown in FIGS. 10-11, the example plug-in connector 200 and corresponding motor head connector (receptacle) implementations described herein may reduce the cost of the installation because there may not be a need for special tools and skilled personnel at the well site to prepare and perform the connection. The plug-in connector 200, as shown in FIG. 10, and the motor head connector shown in FIG. 11 may replace exiting tape-in potheads with minimal changes of the motor head design. Therefore, existing inventory may be utilized, which may further reduce costs.

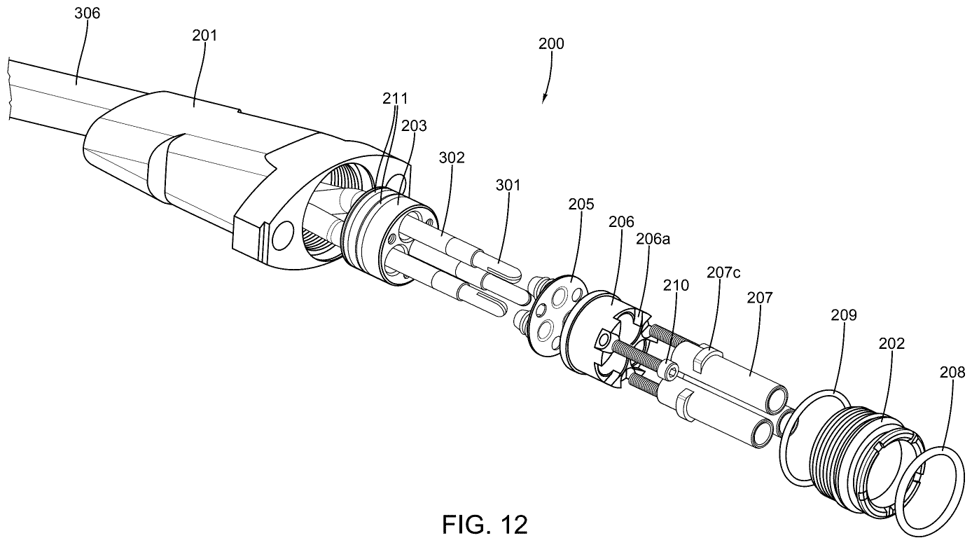

FIG. 12 is a first exploded isometric view depicting the example plug-in pothead 200 and pothead components, according to some implementations. FIG. 12 includes the plug-in pothead 200, pothead housing 201, compression ring 202, the upper compression block 203, the elastomeric seal 205, lower compression block 206, comprising profiled cuts 206a (three are shown), the pin insulating sleeves 207 (three are shown, one for each phase), asymmetric tabs 207c (one for each pin insulating sleeve 207), the O-ring 208, the O-Ring 209, screws 210 (three are shown), O-rings 211 (two are shown), the plug-in pothead male electrical connectors 301 (electrical pin, three are shown), the electrical phases (each including a conductor) 302, and the MLE armor 306. In some implementations, additional or fewer quantities of the above-described components may also be used.

Focusing on the difference between a tape-in and the plug-in pothead 200, some implementations of the insulation system of the electrical pin 301 and at least a portion of the conductors 302 may be comprised of a two-piece construction. For example, the insulation system of the plug-in pothead 200, as depicted in FIG. 12, may include a two-piece construction comprised of the lower compression block 206 and the individual insulating sleeves 207. This arrangement may be implemented if the insulating components are machined from raw material (e.g., PEEK). One advantage of this construction over traditional connector and receptacle systems is in the interchangeability of the lower compression block 206 between different conductor sizes. As described above, at least two different conductor sizes may be used for the conductors 302. Therefore, two different ESP cable sizes may be used for the same pothead size (e.g., with either a 3 or 5 kV rating), matching the cable size to and ultimately leading to cost savings based on the application requirements. The motor head design connector (receptacle) may be common for both ESP cable sizes, which means that same motor may be re-used in an application by changing the MLE 300 only, if necessary. Some implementations of the pothead housing 201 may be slightly larger than those of traditional plug-in potheads to accommodate conductors and/or cables of various sizes. In contrast, traditional pothead and pothead housing designs may not be configured to fit or accommodate different cable sizes within a single pothead housing. Some traditional pothead designs may utilize a different pothead housing for each size of cable (MLE 300).

The lower compression block 206, which may be comprised of PEEK, ceramic, or any other high dielectric strength organic or inorganic insulation material, may serve to both provide compression on the elastomeric seal 205, as well as providing insulation to the electrical pin 301 as part of the pothead insulation system. The individual electrical pins 301 may be joined onto the conductors 302 of the MLE 300 by a threaded connection 310, and the electrical pins 301 may be enclosed in individual insulating sleeves 207 (which may similarly be comprised of PEEK, ceramic, or other high dielectric strength organic/inorganic material). The insulator sleeves 207 may slide over each of the electrical pins 301 and the insulating layer 303 of the conductor 302 (see FIG. 7). The insulator sleeves 207 may engage into the lower compression block 206, creating a radially overlapping insulation layer. This insulation layer may also axially overlap along at least a portion of the length of each conductor 302 and/or pin 301 along an axis of the connector 200. For example, each insulator sleeve 207 and lower compression block 206 may both radially and axially overlap along the creepage path 501, each insulator sleeve 207 and the motor head insulator body 110 may radially and axially overlap along the creepage path 502, etc. The asymmetric tab 207c of the insulator sleeve 207 may ensure that the sleeve 207 is always inserted in the correct orientation into the lower compression block 206, where the lower compression block 206 includes a matching cavity (the profiled cut 206a).

In contrast to traditional plug-in connectors, the plug-in pothead 200 may utilize a different technique of aligning and retaining of the insulating sleeves 207 within the plug-in pothead 200. Accordingly, each of the insulating sleeves 207 may incorporate a respective asymmetric tab 207c which may act as an alignment feature in the lower compression block 206. The lower compression block 206 may exhibit profiled cuts 206a which match the shape of the asymmetric tab 207c, such that the insulating sleeve 207 may only be assembled in a single orientation into the lower compression block 206. This may ensure that the protruding part of the asymmetric tab 207c is always oriented toward the outer diameter of the lower compression block 206. By using this technique, the insulating sleeves 207 may be trapped between the lower compression block 206 and the compression ring 202 when the compression ring 202 is installed into the pothead housing 201, thus preventing the insulating sleeves 207 from falling out from the plug-in pothead 200. Accordingly, in contrast to other plug-in or tape-in pothead designs, there may not be a need for threaded or bonded interfaces between similar insulating sleeves and the lower compression block. Rather, the insulating sleeves 207 may be aligned via the asymmetric tabs 207c to slide into respective cavities of the lower compression block 206 without a threaded connection. During final assembly of the pothead 200, the compression ring 202 may be threaded into the pothead housing 201, trapping the internal components within the pothead housing 201. Thus, no components of the internal insulation system of the pothead 200 may be threaded or joined via a bonded connection to one another.

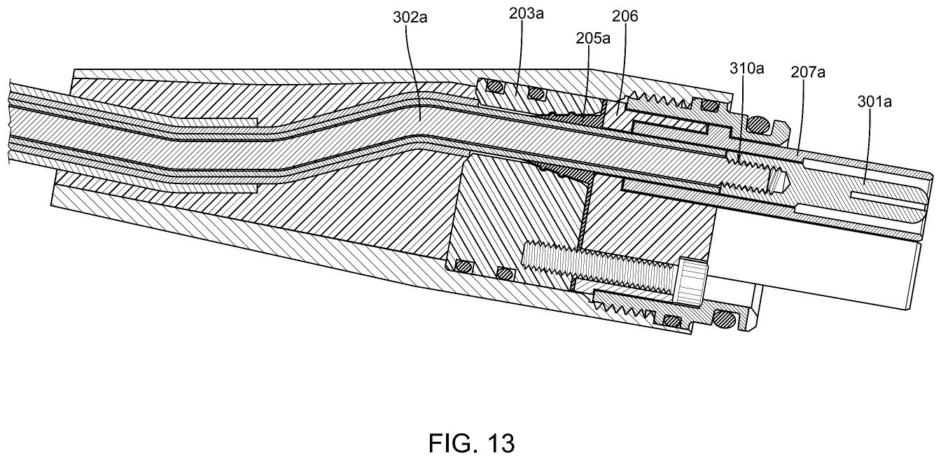

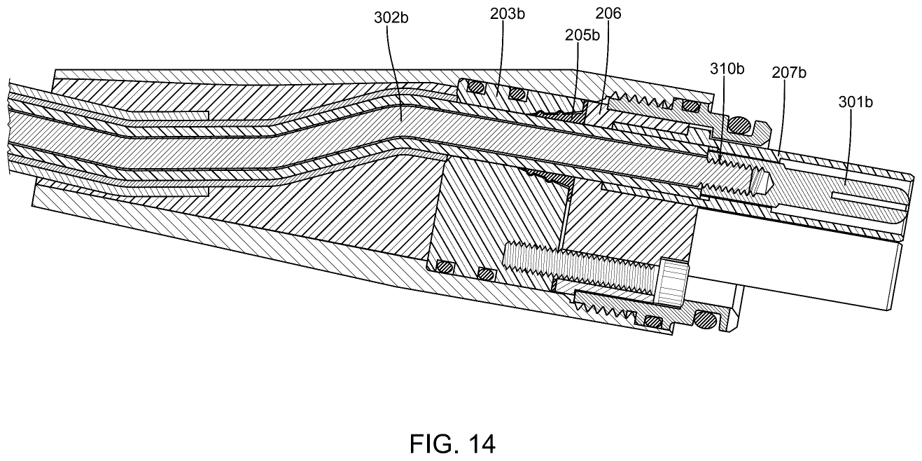

The conductor specific components of the plug-in pothead 200 for use with different conductor sizes are depicted in FIG. 13 and FIG. 14. FIG. 13 is a first axial section view through one of the phases of the example plug-in pothead, showing the example plug-in pothead assembly with one conductor size, according to some implementations. FIG. 13 includes an upper compression block 203a, an elastomeric seal 205a, a lower compression block 206, an insulating sleeve 207a, a male electrical connector 301a for a #7 AWG cable, a #7 AWG conductor 302a (conductor 302a), and a threaded connection 310a. As shown in FIG. 13, the insulation system of the pothead may be comprised of a two-piece insulation system including the lower compression block 206 and the insulating sleeve 207a.

FIG. 14 is a first axial section view depicting one of the phases of the example plug-in pothead, showing the example plug-in pothead assembly with an alternate conductor size, according to some implementations. In some implementations, the diagram of FIG. 14 may depict a different conductor size than the phase depicted in FIG. 13. FIG. 14 includes an upper compression block 203b, an elastomeric seal 205b, a lower compression block 206, an insulating sleeve 207b, a male electrical connector 301b for a #6 AWG, a #6 AWG conductor 302b (conductor 302b), and a threaded connection 310b. Other than the distinctions made between 203a to 310a and 203b to 310b, all other components of the plug-in pothead 200 may be common between the two conductor sizes. Due to the different cable sizes, the threaded connection 310a may be different from the threaded connection 310b. Each of the threaded connections 310a and 310b may be used to thread a male electrical connector (pin) to a conductor within the pothead 200.

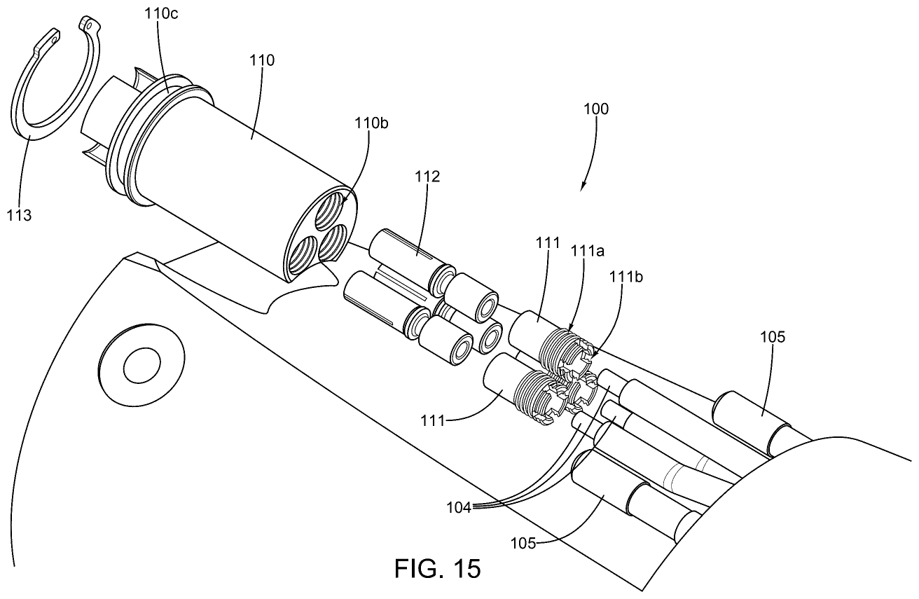

FIG. 15 is an exploded isometric view depicting the example plug-in pothead mating connector (receptacle) of the motor head, according to some implementations.

FIG. 15 includes the motor 100, the motor head 101 (also referred to as the motor head body 101), motor flexible lead extensions (leads) 104 (three are depicted), securing studs 105, the motor head insulator body 110, one or more tapped holes 110b at the rear end of the motor head insulator body 110 (three are shown), an O-ring groove 110c, one or more lock nuts 111 (three are included in FIG. 15), three sets of threads 111a, notches 111b (one set of notches on each set of threads 111a), the female electrical connectors 112, and the retaining ring 113.

To make the plug-in connection possible, the motor head 101 may incorporate a receptacle which may accept the plug-in pothead 200. FIG. 15 depicts an exploded isometric view of this connector. The motor head connector may comprise the motor head insulator body 110, the female electrical connectors 112, the lock nuts 111 and the retaining ring 113. The female connector assembly may be assembled in the following order: the motor flexible lead extensions 104 may be fed through the lock nuts 111, and the female electrical connectors 112 may be soldered, crimped, etc. onto the bare conductor of the motor leads 104. Other techniques to join the female electrical connectors 112 to the motor leads 104 may also be possible. The three motor leads 104 with the attached connectors 112 may then be inserted into the individual cavities (tapped holes 110b) in the motor head insulator body 110 and secured by threading the threads 111a of the lock nuts 111 into the tapped holes 110b of the motor head insulator body 110. To thread the lock nuts 111, notches 111b may be included at the threaded end of each of the lock nuts 111. In some implementations, a custom tool may be used during assembly of the receptacle assembly depicted in FIG. 15. The motor head insulator body 110 may then be pushed back into the pothead bore in the motor head 101. The retaining ring 113 may be used to secure the motor head insulator body 110 inside the motor head 101. In some implementations, the retaining ring 113 may be an inverted retaining ring, whereby the lugs of the retaining ring face outwards, providing a smooth bore and a better clearance than traditional and/or standard internal retaining rings.

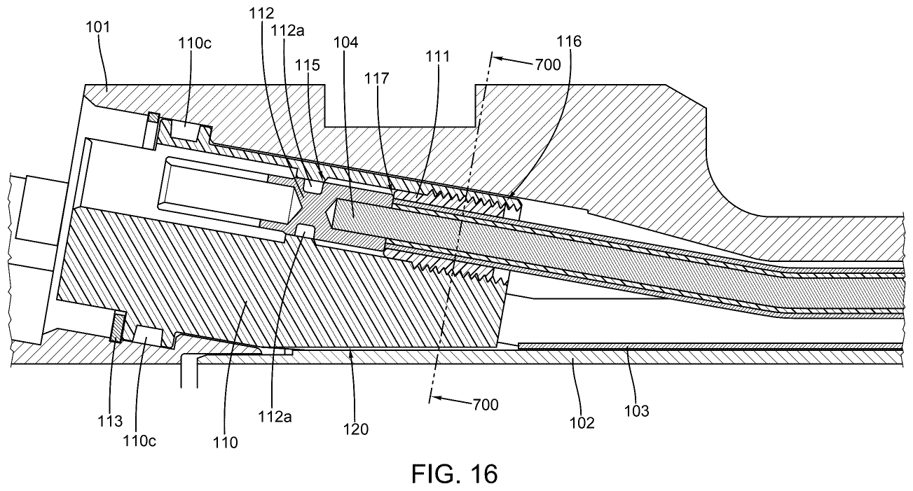

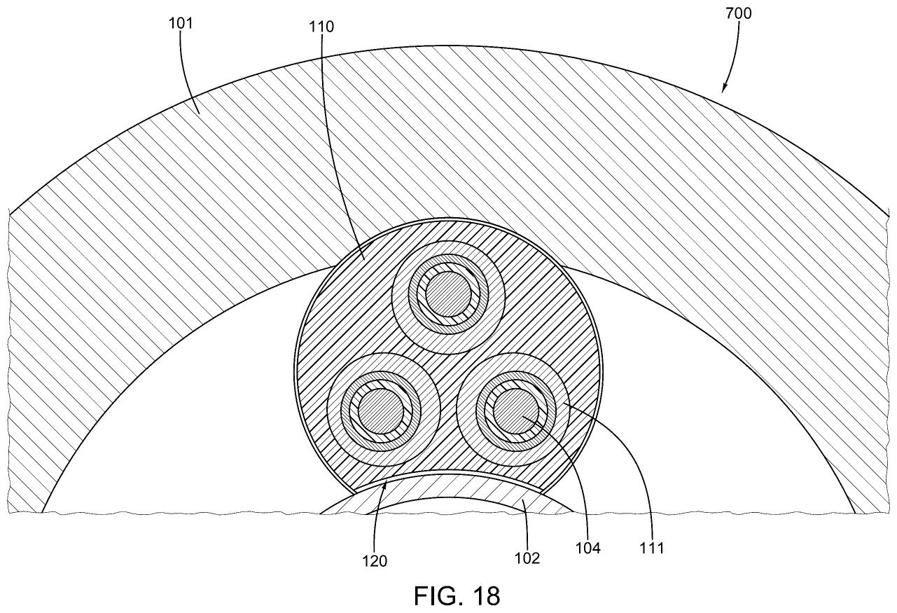

FIG. 16 is a first axial section view depicting one of the phases of the example plug-in pothead mating connector (receptacle) in the motor head, according to some implementations. FIG. 16 includes the motor head 101, the motor lead guard 102, the insulating sleeve 103, the motor flexible leads 104, the motor head insulator body 110, the O-ring groove 110c, the lock nut 111, the female electrical connector 112, an O-ring groove 112a, the retaining ring 113, the contact region 115, the threaded connection 116, a contact region 117, a gap 120, and a radial section 700 view. The radial section view 700 may be described with additional detail in FIG. 18. As shown in FIG. 16, the threaded connection 116 may be formed between the motor head insulator body 110 and locking nut 111 such that it prevents the motor flexible leads 104 from being pulled out of the motor head insulator body 110.

The axial cross section and a detail of this cross section through the motor head 101, as shown in FIGS. 16 and 17, may depict details of the assembled connector in the motor head. FIG. 17 is a detailed view of the axial section of FIG. 16 depicting one of the phases of the example plug-in pothead mating connector (receptacle) in the motor head, according to some implementations. FIG. 17 includes the motor head 101, the motor flexible leads 104, the inner diameter 110d of the individual cavities of the receptacle bore(s) 110a of the motor head insulator body 110, the lock nut 111, the female electrical connector 112 having an outer diameter 112b, the contact region 115, the threaded connection 116, the contact region 117, and the motor cavity 130. In some implementations, the motor cavity 130 may refer to a portion of each receptacle bore 110a behind the female electrical connector 112 and locking nut 111.

The motor head insulator body 110 and the female electrical connector 112 may each incorporate an O-ring groove 110c and 112a, respectively. For example, some implementations may be configured to provide a hermetically sealed motor, and the O-ring grooves 110c and 112a may be configured to provide at least a portion of the hermetic sealing. As shown in FIG. 17, the contact region 115 may be positioned between the motor head insulator body 110 and the female electrical connector 112. The outer diameter 112b of the female electrical connector 112 may be larger than the diameter 110d of the bore 110a in the motor head insulator body 110; therefore the female electrical connector 112 may not be able to pass through the bore. The contact region 117 may be positioned between the female electrical connector 112 and the lock nut 111. The lock nut 111 may ensure that the female electrical connector 112 is trapped inside the motor head insulator body 110 when the threaded connection 116 is made. Some implementations of the locking nut 111 may be preassembled onto each individual motor lead 104.

As described with reference to FIG. 7, the locking nut 111 may be used to lock each of the motor leads 104 and female electrical connectors 112 within each receptacle bore 110a of motor head insulator body 110. The locking nut 111 may be threaded into the motor head insulator body 110, shouldering each female electrical connector 112 of the motor lead 104 between the contact region 115 and contact region 117. Therefore, the motor head female electrical connector 112 may be lodged between two faces and may not be pulled back into the motor cavity 130 or pulled out of the motor. This enables the motor head to receive a plug-in type of connection, where axial movement of the female electrical connector 112 and motor lead 104 into or out of the motor head body 101 is inhibited by the locking nut 111 on one end and the outer diameter 112b of the female electrical connector 112 on the other end. This may lodge each motor lead 104 of the electrical connection between the contact region 115 and contact region 117 for each electrical phase of the connection.

FIG. 18 is a radial section view 700 of FIG. 16 depicting the example plug-in pothead mating connector (receptacle) in the motor head, according to some implementations. FIG. 18 includes the motor head body 101, the motor lead guard 102, the motor flexible lead extensions 104 (three are shown), the motor head insulator body 110, the lock nuts 111 (three are shown), and the gap 120. When the motor head insulator body 110 is installed into the motor 100, a small gap (i.e., the gap 120) may be created between the motor head insulator body 110 and the motor lead guard 102. As shown in FIG. 18, the clearance created by the gap 120 may extend radially and circumferentially between the motor head insulator body 110 and the lead guard 102. The gap 120 may ensure that the motor head insulator body 110 is always correctly installed into the motor head 101. The gap 120 may also prevent the motor head insulator body 110 from rotating inside the pothead bore of the motor head 101, thus eliminating the need for an additional positioning feature/component (e.g., a dowel between the motor head insulator body 110 and the motor head 101).

### Alternate Implementations

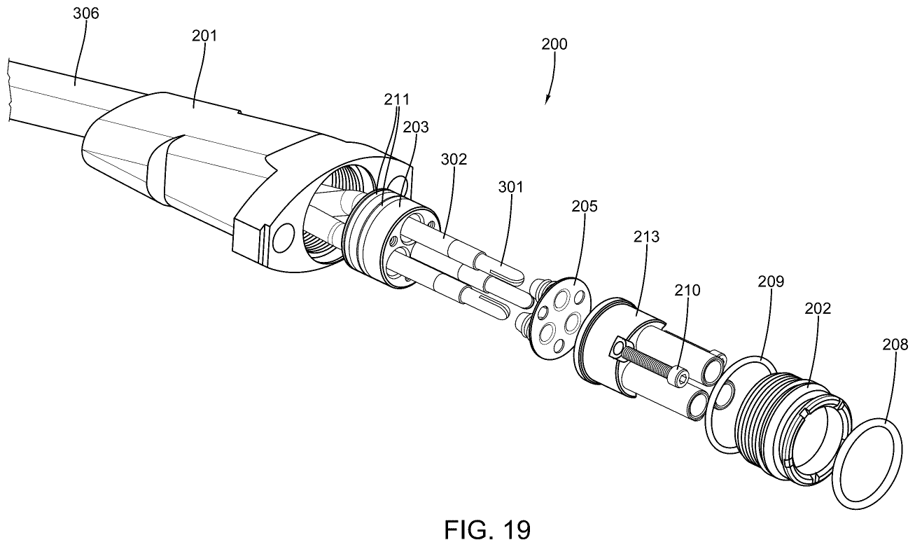

Alternate implementations of the plug-in pothead 200 and motor head body 101 are now described in FIGS. 19-24.

FIG. 19 is a second exploded isometric view depicting the example plug-in pothead and pothead components, according to some implementations. FIG. 19 includes the plug-in pothead 200, the pothead housing 201, the compression ring 202, the upper compression block 203, the elastomeric seal 205, the O-Ring 209, one or more screws 210, one or more O-rings 211, a lower compression block 213, the plug-in pothead male electrical connectors 301 (three are shown), conductors 302 (one for each phase of the electrical connection), and the MLE armor 306. Similar to the lower compression block 206, the lower compression block 213 may be an insulative component of the plug-in connection.

In FIG. 19, some implementations may relate to the insulation system inside the pothead 200. Accordingly, the lower compression block 206 from FIG. 12 may be replaced by a different lower compression block 213. This type of compression block may incorporate the insulating sleeves 207 described in FIG. 12 into a single component. Therefore, instead of using a two-piece insulator comprised of the lower compression block 206 and insulating sleeves 207, the lower compression block 213 may be a singular, monolithic electrical insulator. The lower compression block 213 may be designed for mass production, as it may be molded to near shape from an organic insulator material (e.g., PEEK). “Near shape” may refer to a component that is manufactured and/or molded to be very close to its final dimensions and shape. Accordingly, the component may require minimal additional work to meet the final design specifications. Using the lower compression block 213 with the insulating sleeves incorporated in its construction may minimize the need for extensive finishing processes such as machining. All other components of the plug-in pothead 200 may remain unchanged when compared to those depicted in FIG. 12.

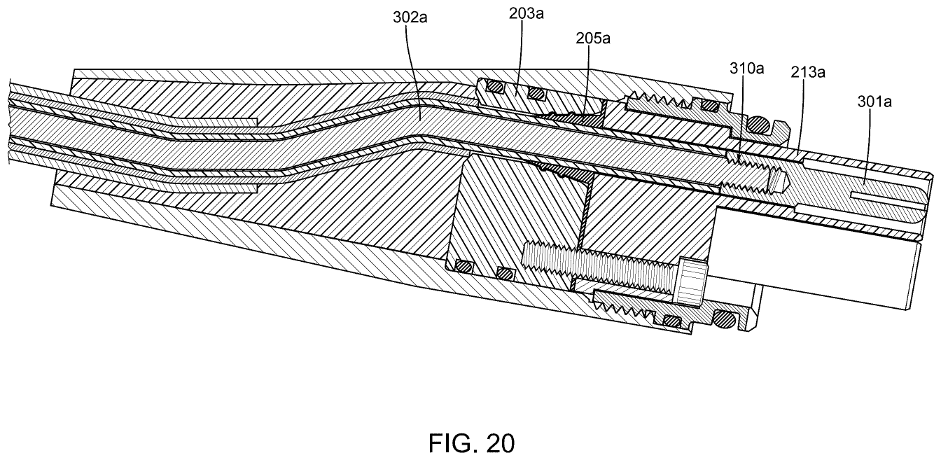

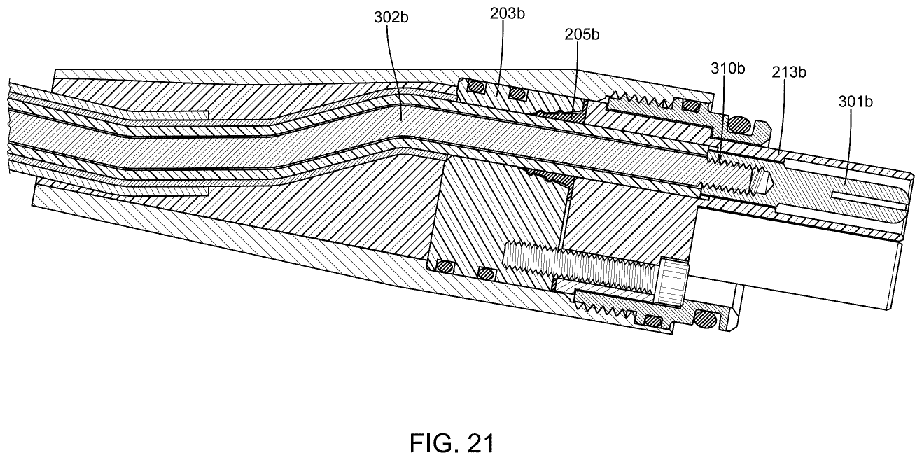

Some implementations of conductor-specific components of the plug-in pothead 200 may be altered due to using different conductor sizes, as depicted in FIG. 20 and FIG. 21. FIGS. 20-21 may describe different cable sizes configured for use within the same pothead 200 and pothead housing 201. Alternate implementations may also include molded and/or machined insulation components suited for mass production, such as the lower compression blocks 213a and 213b. FIG. 20 is a second axial section view depicting one of the phases of the example plug-in pothead 200, showing the assembled plug-in pothead with one conductor size, according to some implementations. FIG. 20 includes the upper compression block 203a, an elastomeric seal 205a, a near shape molded lower compression block 213a, the male electrical connector 301a for a #7 AWG cable, the conductor 302a for a #7 AWG cable, and the threaded connection 310a. The components described with reference to FIG. 20 may be similar to those described in FIG. 13, but with alterations to accommodate the different conductor size. FIG. 20 may also utilize a monolithic electrical insulator, the lower compression block 213a, whereas FIG. 13 includes a two-piece insulator comprised of the lower compression block 206 and insulating sleeves 207.

FIG. 21 is a second axial section view depicting one of the phases of the plug-in pothead, showing the assembled plug-in pothead 200 with an alternate conductor size, according to some implementations. FIG. 21 includes the upper compression block 203b, the elastomeric seal 205b, a molded lower compression block 213b, the male electrical connector 301b for a #6 AWG cable, the conductor 302b for a #6 AWG cable, and the threaded connection 310b. FIG. 21 may be similar to FIG. 14, but the insulation system of FIG. 21 may include a monolithic lower compression block 213b, whereas FIG. 14 includes a two piece insulator (similar to FIG. 13).

All other components of the pothead 200, as depicted in FIGS. 20-21, may be common between the two conductor sizes. Due to the different cable sizes, the threaded connection 310a may be different from the threaded connection 310b. In some implementations, the molded lower compression block 213 (213a and 213b), as depicted in FIGS. 20-21, may be interchangeable with the lower compression block 206 and individual insulating sleeves 207 from FIGS. 13-14, with all the other components of the pothead being common between these configurations.

A benefit of using the molded lower compression block 213a and/or 213b consists in reducing manufacturing costs and minimizing inventory. For example, the molded lower compression block 213b (for the #6 AWG conductor) may be manufactured from the near shape molded lower compression block 213a by increasing the diameter of the individual conductor through holes to a predefined depth.

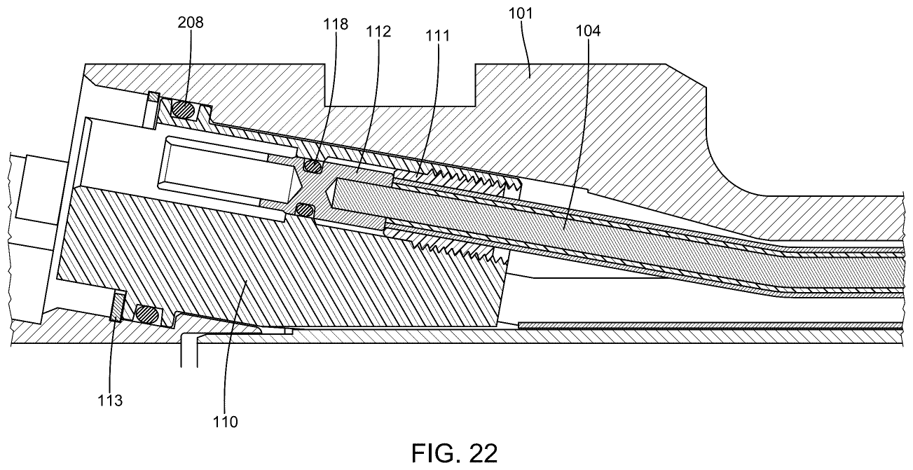

Some implementations may include components configured to provide a hermetically sealed motor. FIG. 22 is a second axial section view depicting one of the phases of the example plug-in pothead mating connector (receptacle) in the motor head, according to some implementations. FIG. 22 includes the motor head body 101, the motor flexible lead extension 104, the motor head insulator body 110, the lock nut 111, the motor head female electrical connector 112, the retaining ring 113, the O-ring 118, and an O-ring 208. FIG. 22 may be similar to FIG. 16, with the addition of the hermetic sealing capability provided by the O-rings 118 and 208. Both the plug-in pothead 200 and the mating connector in the motor head may be configured for both unsealed and sealed configurations.

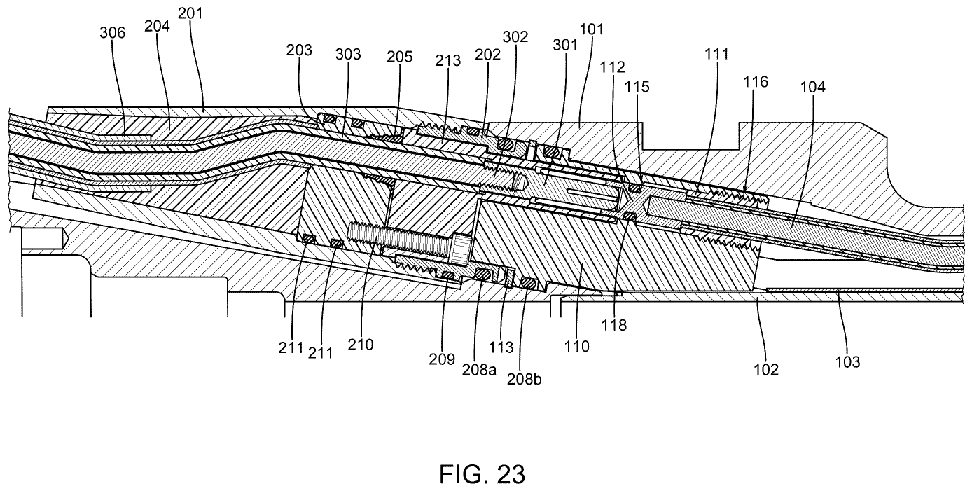

FIG. 23 is a second axial section view depicting one of the phases of the example plug-in pothead and motor head connector (receptacle), showing the example plug-in pothead in a mated state, according to some implementations. FIG. 23 includes the motor head body 101, the motor lead guard 102, insulating sleeve 103, the motor flexible lead extension 104, the motor head insulator body 110, the lock nut 111, the motor head female electrical connector 112, the retaining ring 113, the contact region 115, the threaded connection 116, the O-ring 118, the pothead housing 201, the compression ring 202, the upper compression block 203, the epoxy resin 204, the elastomeric seal 205, the lower compression block 206, the insulator sleeve 207, O-rings 208a and 208b (which may generally be referred to as the O-rings 208), the O-Ring 209, the screw 210, O-rings 211, the plug-in pothead male electrical connector 301, the conductor 302, the insulation layer 303, and the MLE armor 306. FIG. 23 may be similar to FIG. 7; where FIG. 23 may differ is in the inclusion of the O-rings 118 and 208 to provide a hermetic seal.

In some implementations, the O-rings 118 and 208 may be comprised of an elastomeric material, such as rubber, to provide hermetic seals for the motor 100. Other elastomeric materials may also be used for the O-rings 118 and 208. However, other implementations configured for high temperature applications (e.g., operating temperatures exceeding 350° F.), such as operations in steam assisted gravity drainage (SAGD) wells, may include sealing elements comprised of a metal or alloy, such as steel. Some implementations configured for high temperature applications may use graphite sealing gaskets, C-rings comprised of a metal, metalloid, or metal alloy, etc. in place of the O-rings 118 and 208. In some implementations, other O-rings, such as the O-rings 211, may also be replaced with any one of the above configurations for high temperature applications. Other implementations may also be possible.

With reference to FIG. 16, an O-ring 208 may be installed in the O-ring groove 110c of the motor head insulator body 110. With reference to FIG. 16, an O-ring 118 may be installed in the O-ring groove 112a of the female connector 112. By installing an O-ring 208 into the O-ring groove 110c in the motor head insulator body 110, and by installing the O-ring 118 into the O-ring groove 112a of each of the female electrical connectors 112, the leak paths from the motor 100 to the environment may be blocked. This sealed configuration may provide additional benefits by stopping any potential contaminants from entering the motor through this electrical connection (debris barrier). Some implementations of the hermetically sealed motor 100 may also allow for the motor to be serviced in the workshop prior to shipping out to the field, thus eliminating the need for field servicing of the motor. For example, the O-rings 208 and 118 may be positioned around each conductor 302 of the pothead 200, and the motor may be pre-serviced in the shop. Therefore, there may be no need to service the motor in the field, as the O-rings 208 and 118 may prevent debris and fluid from entering the motor head body 101 of the motor.

In some implementations, both the pothead housing 201 of the plug-in connector and the motor head insulator body 110 of the motor head assembly, as shown in FIG. 23, may use the same O-ring 208. For example, the O-ring 208a may be installed in the pothead housing 201, and the O-ring 208b may be installed in the motor head insulator body 110. The O-ring 208a and O-ring 208b may have the same dimensions and material. Therefore, using O-rings common to both components may reduce inventory.

The O-rings 208a and 208b (either of which may generally be referred to as the O-ring 208, one of each are shown) may prevent external contaminant ingress, such as wellbore fluid, from entering behind the pothead housing 201 and into the motor cavity 130. For example, wellbore fluid may attempt to enter the electrical connection through a leak path where the MLE 300 terminates into the epoxy resin 204, particularly below the connector 200. A pair of O-rings, such as the O-rings 208a and 208b, may halt contaminant ingress external to the pothead housing 201 from entering the motor 100. Similarly, the O-ring 118 may be configured to stop an internal contaminant ingress (dust, fluids, etc.) within the connector 200 from entering the motor via the MLE 300. For example, should a fluid bypass various sealing elements and seep into the connector along an outer surface of the insulation layer 303, contaminant/fluid ingress internal to the pothead housing 201 may be prevented from entering the motor via the O-ring(s) 118 (there may be one O-ring 118 per receptacle bore 110a). Thus, the O-rings 118 and 208 may hermetically seal the motor 100 to prevent contamination of the connector or connector housing 201 from entering the motor. Accordingly, potential motor failures in the electrical connection between the pothead and motor head assembly may be isolated to the pothead itself. A damaged pothead may be readily replaced, but the motor hardware itself may be spared from significant damage, such as electrical shorting and damage to the stator.

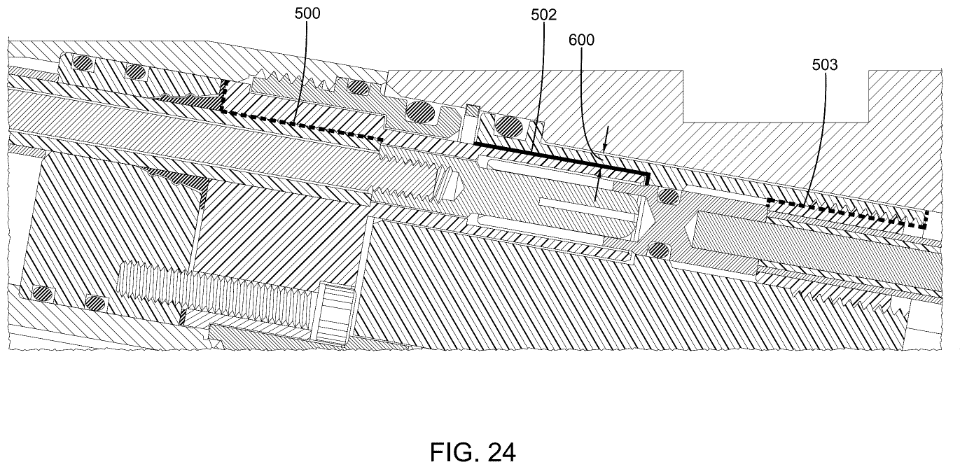

FIG. 24 is a second illustration depicting example creepage paths and a minimum insulation thickness of the mated plug-in pothead, according to some implementations. FIG. 24 includes the creepage path 500, the creepage path 502, the creepage path 503, and the minimum wall thickness 600. FIG. 24 may be similar to FIG. 8, but FIG. 24 may include an alternative configuration. As shown in FIG. 24, the creepage path 501 (shown in FIG. 8) may be eliminated due to the single piece construction of the monolithic lower compression block 213. The other creepage paths 500, 502, 503, the wall thickness 600, and the flashover and breakdown voltage values may remain unchanged. The elimination of the creepage path 501 may occur for each conductor 302 of the connection; therefore, three creepage paths from a conductor to ground may be eliminated from the plug-in connection. Because the creepage path 501 also intersects the creepage path 500, an additional three creepage paths may be eliminated. Therefore, the use of a single-piece insulator, the lower compression block 213, may eliminate six creepage paths across the plug-in connection.

### Example Well System

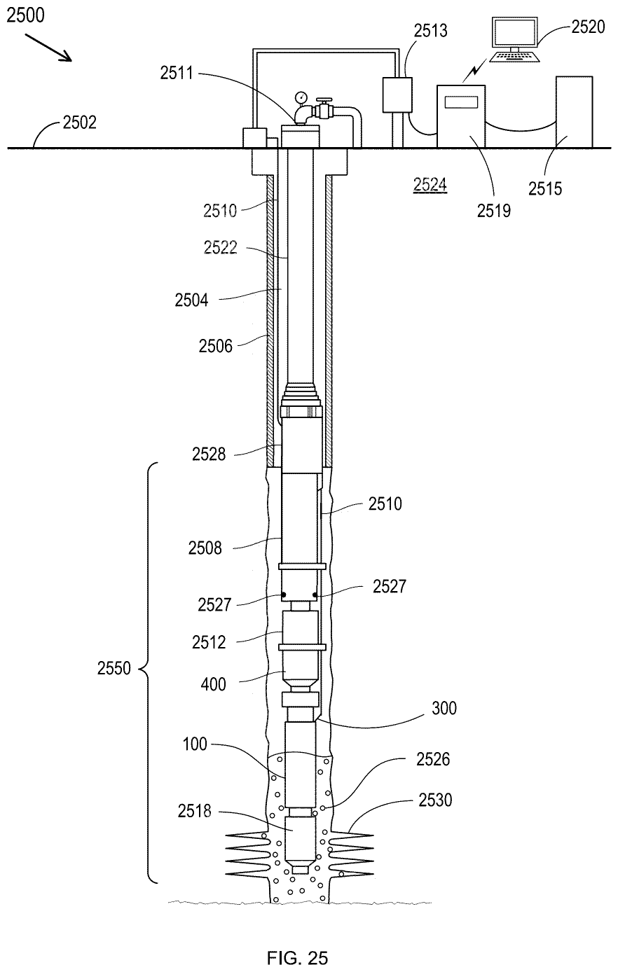

FIG. 25 is an illustration depicting an example well system having an ESP, according to some implementations. A well system 2500 may include a surface 2502, a wellbore 2504, a casing 2506, an electrical submersible pump 2508 (“pump 2508”), a power cable 2510, a wellhead 2511, a gas separator 2512, a junction box 2513, the seal section 400, a transformer 2515, the motor 100, a sensor 2518 (also referred to as a gauge), a variable speed drive (VSD) 2519, a controller 2520, a production tubing 2522 (“tubing 2522”), a subsurface 2524 including one or more subsurface formations, a fluid 2526, one or more intake ports 2527, a pump discharge 2528, perforations 2530, the motor lead extension (MLE) 300, and an ESP system 2550. While the well system 2500 is depicted within a land-based subterranean environment, other implementations of the well system 2500 may employ any well site environment including a subsea environment. In some implementations, any one or more components or elements described may be used with subterranean operations and/or equipment located on offshore platforms, drill ships, semi-submersibles, drilling barges, land-based rigs, etc.

The well system 2500 may represent an applicable environment in which a substance may be pumped through the wellbore 2504 toward the surface 2502. For example, various types of hydrocarbons or fluids may be pumped or otherwise transported from the wellbore 2504 to the surface 2502. In some implementations, the well system 2500 may be positioned (at least partially) in the wellbore 2504 below the surface 2502 in one or more subsurface formations of the subsurface 2524. The wellbore 2504 may comprise a vertical, deviated, horizontal, or any other type of wellbore. The wellbore 2504 may be defined in part by a casing 2506 that may extend from the surface 2502 to a selected downhole location. Portions of the wellbore 2504 that do not comprise the casing may be referred to as open hole.

The power cable 2510 may extend from the surface 2502 down to the ESP system 2550. The power cable 2510 may comprise one or more cables configured to convey power from power generation or power storage equipment at the surface 2502 to the motor 100. In some implementations, the power cable 2510 may be a round cable, a flat cable, any combination thereof, or of any other suitable geometry. In some implementations, the power cable 2510 may be configured to convey data to and from the equipment at the surface 2502 and the ESP system 2550 in addition to supplying power to the motor 100. In some implementations, the data may comprise one or more control or operational instructions transmitted via the controller 2520, to which the power cable 2510 may be communicatively coupled with. Accordingly, the power cable 2510 may be communicatively coupled with at least the junction box 2513, transformer 2515, VSD 2519, and controller 2520. The power cable 2510 may be conveyed from the surface 2502 and may terminate into the MLE 300. The MLE 300 may be coupled to a motor head of the motor 100 via a pothead/connector, where the MLE is configured to provide electrical power to the motor 100.

### Example Method of Operations

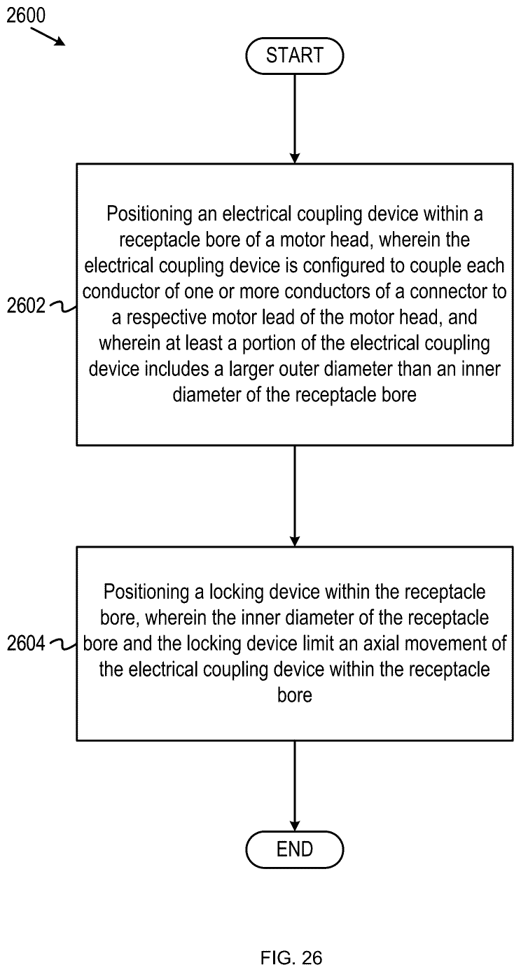

FIG. 26 is a flowchart depicting an example method of operations, according to some implementations. Operations of a method 2600 may be performed by software, firmware, hardware, or a combination thereof. Such operations are described with reference to FIGS. 1-25. However, such operations may be performed by other systems or components. The operations of the method 2600 begin at block 2602.

At block 2602, the method 2600 includes positioning an electrical coupling device within a receptacle bore of a motor head, wherein the electrical coupling device is configured to couple each conductor of one or more conductors of a connector to a respective motor lead of the motor head, and wherein at least a portion of the electrical coupling device includes a larger outer diameter than an inner diameter of the receptacle bore. For example, the motor head body 101 may be part of the motor 100 coupled with the pump 2508 as part of the ESP system 2550 within the wellbore 2504. The motor head body 101, particularly the motor head insulator body 110, may include a plurality of receptacle bores 110a each configured to receive an electrical pin 301 of a conductor 302 of the plug-in pothead 200. Each receptacle bore 110a may include an electrical coupling device such as the female electrical connector 112, the female electrical connector 112 configured to couple each motor lead 104 to each respective electrical pin 301. As seen in FIG. 17, at least a portion of the female electrical connector 112 may include a larger outer diameter 112b than at least a portion of an inner diameter 110d of the receptacle bore 110a. Flow progresses to block 2604.

At block 2604, the method 2600 includes positioning a locking device within the receptacle bore, wherein the inner diameter of the receptacle bore and the locking device limit an axial movement of the electrical coupling device within the receptacle bore. For example, the locking nut 111 may be positioned behind the female electrical connector 112 within the receptacle bore 110a. The locking nut 111 may form a threaded connection 116 with the threads of the receptacle bore 110a. The female electrical connector 112 may then be trapped in the receptacle bore 110a between inner diameter 110d and the locking nut 111. By trapping the female electrical connector 112 within the bore 110a, axial movement of each female electrical connector 112 and its respective motor lead 104 further into (i.e., into the motor cavity 130) or out of the receptacle bore 110a may be limited. Limiting the axial movement of the female electrical connector 112 may configure the motor head body 101 to form the plug-in connection with the plug-in pothead 200, as the motor leads 104 and female electrical connectors 112 may not move when connecting or disconnecting the plug-in pothead 200 from the motor head 101. Flow of the method 2600 ceases.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable sub-combination. Moreover, although features may be described as acting in certain combinations and even initially claimed as such, one or more features from a claimed combination may in some cases be excised from the combination, and the claimed combination may be directed to a sub-combination or variation of a sub-combination.

While operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” may be infringed with only one of the listed items, multiple of the listed items, and one or more of the items in the list and another item not listed. Similarly, “at least one of: a, b, or c” is intended to cover: a, b, c, a-b, a-c, b-c, and a-b-c.

Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well may be horizontal or even slightly directed upwards. Unless otherwise specified, use of the terms “subsurface formation” or “subterranean formation” shall be construed as encompassing both areas below exposed earth and areas below earth covered by water such as ocean or fresh water.

### Example Implementations

Implementation #1: A system comprising: a connector configured to electrically couple a motor lead extension (MLE) to an electric motor of an electrical submersible pump (ESP) to be positioned in a wellbore, wherein the connector includes a first set of cavities each including a first conductor; and a motor head of the electric motor including a second set of cavities configured to receive the first conductors of the connector, each cavity of the second set of cavities including, a second conductor, an electrical coupling device configured to electrically couple each of the first conductors to a respective second conductor, a set of threads, a locking device configured to form a threaded connection with the set of threads, wherein the locking device is configured to prevent an axial movement of the electrical coupling device and the second conductor within each cavity of the second set of cavities.
Implementation #2: The system of Implementation 1, wherein the connector is configured to form a plug-in connection with the motor head, and wherein the locking device configured to prevent the axial movement of the electrical coupling device and the second conductor enables the connector to form the plug-in connection with the motor head.
Implementation #3: The system of any one or more of Implementations 1-2, wherein the electrical coupling device includes a larger outer diameter than at least a portion of an inner diameter of each of the second set of cavities, and wherein the locking device and the larger outer diameter of the electrical coupling device limit the axial movement of the electrical coupling device.
Implementation #4: The system of any one or more of Implementations 1-3, wherein the connector further comprises: a cylindrical insulating block having a third set of cavities, wherein the cylindrical insulating block is configured to insulate at least a portion of the first conductors; a first set of insulating sleeves configured to insulate the first conductors; and an alignment feature disposed on an outer surface of each insulating sleeve of the first set of insulating sleeves, wherein each insulating sleeve of the first set of insulating sleeves is configured to slide into a respective cavity of the third set of cavities, and wherein the first conductors are configured to pass through the third set of cavities and the first set of insulating sleeves.
Implementation #5: The system of any one or more of Implementations 1-4, wherein the first set of insulating sleeves are held in place within the third set of cavities of the cylindrical insulating block via compression.
Implementation #6: The system of any one or more of Implementations 1-5, wherein at least a portion of the cylindrical insulating block and at least a portion of the first set of insulating sleeves are configured to axially and radially overlap.
Implementation #7: The system of any one or more of Implementations 1-6, wherein the connector further comprises: a monolithic insulator comprised of the first set of insulating sleeves and the cylindrical insulating block, wherein the monolithic insulator is formed from at least one of a molding process or a machining process.
Implementation #8: The system of any one or more of Implementations 1-7, wherein the connector further comprises: a connector housing configured to house a first cable, wherein the first cable includes conductors of a first wire gauge.
Implementation #9: The system of any one or more of Implementations 1-8, wherein the connector housing is configured to house a second cable, wherein the second cable includes conductors of a second wire gauge.
Implementation #10: The system of any one or more of Implementations 1-9, further comprising: a first O-ring positioned within a groove of a compression ring of the connector; a second O-ring positioned within a groove of an insulator body of the motor head, wherein the first O-ring and the second O-ring are configured to hermetically seal the electric motor from a contaminant ingress external to the connector housing; and a third O-ring positioned within a groove of the electrical coupling device, wherein the third O-ring is configured to hermetically seal the electric motor from a contaminant ingress internal to the connector housing.
Implementation #11: An apparatus comprising: a connector configured to electrically couple a motor lead extension (MLE) to an electric motor of an electrical submersible pump (ESP) to be positioned in a wellbore, the connector including, a first set of cavities each including a first conductor, a cylindrical insulating block having a second set of cavities, wherein the cylindrical insulating block is configured to insulate at least a portion of the first conductors, and a first set of insulating sleeves configured to insulate the first conductors.
Implementation #12: The apparatus of Implementation 11, further comprising: an alignment feature disposed on an outer surface of each insulating sleeve of the first set of insulating sleeves, wherein each insulating sleeve of the first set of insulating sleeves is configured to slide into a respective cavity of the second set of cavities, and wherein the first conductors are configured to pass through the second set of cavities and the first set of insulating sleeves.
Implementation #13: The apparatus of any one or more of Implementations 11-12, wherein at least a portion of the cylindrical insulating block and at least a portion of the first set of insulating sleeves are configured to axially and radially overlap, and wherein the first set of insulating sleeves are held in place within the second set of cavities of the cylindrical insulating block via compression.
Implementation #14: The apparatus of any one or more of Implementations 11-13, further comprising: a monolithic insulator comprised of the first set of insulating sleeves and the cylindrical insulating block, wherein the monolithic insulator is formed from at least one of a molding process or a machining process.
Implementation #15: The apparatus of any one or more of Implementations 11-14, further comprising: a connector housing configured to house a first cable, wherein the first cable includes conductors of a first wire gauge.
Implementation #16: The apparatus of any one or more of Implementations 11-15, wherein the connector housing is configured to house a second cable, wherein the second cable includes conductors of a second wire gauge.
Implementation #17: The apparatus of any one or more of Implementations 11-16, further comprising: a first O-ring positioned within a groove of a compression ring of the connector, wherein the connector is configured to couple with a motor head of the electric motor, and wherein the first O-ring is configured to hermetically seal, at least in part, the electric motor from contaminant ingress external to the connector housing.
Implementation #18: A method comprising: configuring a motor head of an electric motor to form a plug-in connection with a connector having one or more conductors, wherein the electric motor is coupled with an electrical submersible pump to be positioned in a wellbore, wherein configuring the motor head to form the plug-in connection with the connector comprises, positioning an electrical coupling device within a receptacle bore of the motor head, wherein the electrical coupling device is configured to couple each conductor of the one or more conductors to a respective motor lead of the motor head, and wherein at least a portion of the electrical coupling device includes a larger outer diameter than an inner diameter of the receptacle bore, and positioning a locking device within the receptacle bore, wherein the inner diameter of the receptacle bore and the locking device limit an axial movement of the electrical coupling device within the receptacle bore.
Implementation #19: The method of Implementation 18, wherein limiting the axial movement of the electrical coupling device within the receptacle bore limits an axial movement of each respective motor lead, and wherein limiting the axial movement of the electrical coupling device enables the plug-in connection.
Implementation #20: The method of any one or more of Implementations 18-19, further comprising: forming an insulation system within the connector to insulate each of the one or more conductors, wherein forming the insulation system includes, for each conductor, sliding an insulating sleeve into a respective cavity of a cylindrical insulating block, wherein the insulating sleeve and cylindrical insulating block are coupled via compression, and wherein at least a portion of the insulating sleeve and the cylindrical insulating block are configured to axially and radially overlap.
Implementation #21: The method of any one or more of Implementations 18-20,further comprising: forming a monolithic insulator in the connector by at least one of a molding process or a machining process, wherein the monolithic insulator is comprised of the cylindrical insulating block and the insulating sleeves.
Implementation #22: The method of any one or more of Implementations 18-21,further comprising: positioning the one or more conductors within a housing of the connector, wherein the one or more conductors are included within a first cable, and wherein the one or more conductors include conductors of a first wire gauge.
Implementation #23: The method of any one or more of Implementations 18-22, further comprising: positioning the one or more conductors within the housing of the connector, wherein the one or more conductors are included within a second cable, and wherein the one or more conductors include conductors of a second wire gauge.

1. A system comprising:
a connector configured to electrically couple a motor lead extension (MLE) to an electric motor of an electrical submersible pump (ESP) to be positioned in a wellbore, wherein the connector includes a first set of cavities each including a first conductor; and
a motor head of the electric motor including a second set of cavities configured to receive the first conductors of the connector, each cavity of the second set of cavities including,
a second conductor,
an electrical coupling device configured to electrically couple each of the first conductors to a respective second conductor,
a set of threads, and
a locking device configured to form a threaded connection with the set of threads, wherein the locking device is configured to prevent an axial movement of the electrical coupling device and the second conductor within each cavity of the second set of cavities.

2. The system of claim 1, wherein the connector is configured to form a plug-in connection with the motor head, and wherein the locking device configured to prevent the axial movement of the electrical coupling device and the second conductor enables the connector to form the plug-in connection with the motor head.

3. The system of claim 1, wherein the electrical coupling device includes a larger outer diameter than at least a portion of an inner diameter of each of the second set of cavities, and wherein the locking device and the larger outer diameter of the electrical coupling device limit the axial movement of the electrical coupling device.

4. The system of claim 1, wherein the connector further comprises:
a cylindrical insulating block having a third set of cavities, wherein the cylindrical insulating block is configured to insulate at least a portion of the first conductors;
a first set of insulating sleeves configured to insulate the first conductors; and
an alignment feature disposed on an outer surface of each insulating sleeve of the first set of insulating sleeves,
wherein each insulating sleeve of the first set of insulating sleeves is configured to slide into a respective cavity of the third set of cavities, and wherein the first conductors are configured to pass through the third set of cavities and the first set of insulating sleeves.

5. The system of claim 4, wherein the first set of insulating sleeves are held in place within the third set of cavities of the cylindrical insulating block via compression.

6. The system of claim 4, wherein at least a portion of the cylindrical insulating block and at least a portion of the first set of insulating sleeves are configured to axially and radially overlap.

7. The system of claim 4, wherein the connector further comprises:
a monolithic insulator comprised of the first set of insulating sleeves and the cylindrical insulating block, wherein the monolithic insulator is formed from at least one of a molding process or a machining process.

8. The system of claim 1, wherein the connector further comprises:
a connector housing configured to house a first cable, wherein the first cable includes conductors of a first wire gauge.

9. The system of claim 8, wherein the connector housing is configured to house a second cable, wherein the second cable includes conductors of a second wire gauge.

10. The system of claim 8, further comprising:
a first O-ring positioned within a groove of a compression ring of the connector;
a second O-ring positioned within a groove of an insulator body of the motor head, wherein the first O-ring and the second O-ring are configured to hermetically seal the electric motor from a contaminant ingress external to the connector housing; and
a third O-ring positioned within a groove of the electrical coupling device, wherein the third O-ring is configured to hermetically seal the electric motor from a contaminant ingress internal to the connector housing.

11. An apparatus comprising:
a connector configured to electrically couple a motor lead extension (MLE) to an electric motor of an electrical submersible pump (ESP) to be positioned in a wellbore, the connector including,
a first set of cavities each including a first conductor,
a cylindrical insulating block having a second set of cavities, wherein the cylindrical insulating block is configured to insulate at least a portion of the first conductors, and
a first set of insulating sleeves configured to insulate the first conductors.

12. The apparatus of claim 11, further comprising:
an alignment feature disposed on an outer surface of each insulating sleeve of the first set of insulating sleeves,
wherein each insulating sleeve of the first set of insulating sleeves is configured to slide into a respective cavity of the second set of cavities, and wherein the first conductors are configured to pass through the second set of cavities and the first set of insulating sleeves.

13. The apparatus of claim 11, wherein at least a portion of the cylindrical insulating block and at least a portion of the first set of insulating sleeves are configured to axially and radially overlap, and wherein the first set of insulating sleeves are held in place within the second set of cavities of the cylindrical insulating block via compression.

14. The apparatus of claim 11, further comprising:
a monolithic insulator comprised of the first set of insulating sleeves and the cylindrical insulating block, wherein the monolithic insulator is formed from at least one of a molding process or a machining process.

15. The apparatus of claim 11, further comprising:
a connector housing configured to house a first cable, wherein the first cable includes conductors of a first wire gauge.

16. The apparatus of claim 15, wherein the connector housing is configured to house a second cable, wherein the second cable includes conductors of a second wire gauge.

17. The apparatus of claim 15, further comprising:
a first O-ring positioned within a groove of a compression ring of the connector,
wherein the connector is configured to couple with a motor head of the electric motor, and
wherein the first O-ring is configured to hermetically seal, at least in part, the electric motor from contaminant ingress external to the connector housing.

18. A method comprising:
configuring a motor head of an electric motor to form a plug-in connection with a connector having one or more conductors, wherein the electric motor is coupled with an electrical submersible pump to be positioned in a wellbore, wherein configuring the motor head to form the plug-in connection with the connector comprises,
positioning an electrical coupling device within a receptacle bore of the motor head, wherein the electrical coupling device is configured to couple each conductor of the one or more conductors to a respective motor lead of the motor head, and wherein at least a portion of the electrical coupling device includes a larger outer diameter than an inner diameter of the receptacle bore, and
positioning a locking device within the receptacle bore, wherein the inner diameter of the receptacle bore and the locking device limit an axial movement of the electrical coupling device within the receptacle bore.

19. The method of claim 18, wherein limiting the axial movement of the electrical coupling device within the receptacle bore limits an axial movement of each respective motor lead, and wherein limiting the axial movement of the electrical coupling device enables the plug-in connection.

20. The method of claim 18, further comprising:
forming an insulation system within the connector to insulate each of the one or more conductors, wherein forming the insulation system includes,
for each conductor, sliding an insulating sleeve into a respective cavity of a cylindrical insulating block, wherein the insulating sleeve and cylindrical insulating block are coupled via compression, and wherein at least a portion of the insulating sleeve and the cylindrical insulating block are configured to axially and radially overlap.

21. The method of claim 20, further comprising:
forming a monolithic insulator in the connector by at least one of a molding process or a machining process, wherein the monolithic insulator is comprised of the cylindrical insulating block and the insulating sleeves.

22. The method of claim 18, further comprising:
positioning the one or more conductors within a housing of the connector, wherein the one or more conductors are included within a first cable, and wherein the one or more conductors include conductors of a first wire gauge.

23. The method of claim 22, further comprising:
positioning the one or more conductors within the housing of the connector, wherein the one or more conductors are included within a second cable, and wherein the one or more conductors include conductors of a second wire gauge.
